(19) United States
(12) Patent Application Publication
(10) Pub. No.: US 2025/0278792 A1
(43) Pub. Date: Sep. 4, 2025

(54) LEAD-IDENTIFYING PLATFORM UTILIZING CRM INTEGRATION AND ARTIFICIAL INTELLIGENCE

(71) Applicant: Compound Tech LLC, Riverside, CT (US)

(72) Inventors: Patrick Wales, Riverside, CT (US); Matthew Wales, Charleston, SC (US); Aaron Cohen, Charleston, SC (US); Michael Wales, Riverside, CT (US)

(73) Assignee: Compound Tech LLC, Riverside, CT (US)

(21) Appl. No.: 18/594,855

(22) Filed: Mar. 4, 2024

Related U.S. Application Data
(63) Continuation-in-part of application No. 17/822,993, filed on Aug. 29, 2022, now abandoned.
(60) Provisional application No. 63/247,047, filed on Sep. 22, 2021.

(51) Int. Cl. G06Q 40/08; G06F 40/284; G06F 40/289; G06Q 50/00

(52) U.S. Cl. CPC G06Q 40/08; G06F 40/284; G06F 40/289; G06Q 50/01

(57) ABSTRACT

A lead-identification software platform relating to identification of clients for insurance carriers and other benefits vendors, including functionality for automatically scraping contact information of key decisionmakers, enabling a precise, targeted experience for identifying clients. The lead-identification system is configured for users to identify new leads based on aggregated Form 5500 data, data from social media profiles, and personal contact information, including location-sensitive information. The location-sensitive information is able to determine likely broker offices servicing particular employers and even particular broker contacts to allow for more precise lead-generation. The software platform includes artificial intelligence algorithms for filtering and aggregating data to identify new opportunities.

### CROSS REFERENCES TO RELATED APPLICATIONS

This application is related to and claims priority from the following U.S. patents and patent applications. This application is a continuation-in-part of U.S. patent application Ser. No. 17/822,993, filed Aug. 29, 2022, which claims priority to and the benefit of U.S. Provisional Application No. 63/247,047, filed Sep. 22, 2021, each of which is incorporated herein by reference in its entirety.

### BACKGROUND OF THE INVENTION

### 1. Field of the Invention

The present invention relates to software platforms for client lead generation based on brokers, service providers, benefits vendors, insurance carriers, third-party administrators and other plan professionals of health care benefits and pension plans and more specifically to an end-to-end prospecting platform utilizing natural language processing to reverse engineer client lists.

### 2. Description of the Prior Art

It is generally known in the prior art to collect information from publicly available documents.

Prior art patent documents include the following:

US Patent Pub. No. 2008/0288300 for Data processing system and method by inventors Emling, et al., filed May 16, 2008 and published Nov. 20, 2008, is directed to a data processing system including a database, a file server coupled to the database, a template engine coupled to the file server. The template engine being configured to create a plurality of insurance brokerage industry templates. The system further including an application service provider interface logic coupled to the file server and the template engine. The application service provider interface logic being configured to receive commands via a communication network from a client device to access an open platform template library in the database and retrieve one of the plurality of insurance brokerage industry templates.

U.S. Pat. No. 10,127,614 for Investment evaluator by inventors Carmody, et al., filed Jul. 27, 2017 and issued Nov. 13, 2018, is directed to a system, method and software for evaluating investments. In one example, managed trust investments are analyzed with respect to one or more indexes. An indication is created of how the managed investment compares to the one or more indexes or their own benchmarks, and suggested changes to the managed investment may be presented.

US Patent Pub. No. 2008/0294468 for Process for automating and simplifying commercial insurance transactions by inventor Toland, Jr., filed May 20, 2008 and published Nov. 27, 2008, is directed to a process for automating and simplifying commercial insurance transactions, particularly at the broker level. Insurance transactions between brokers and insurance companies are automated and simplified through software processes. This is done by maintaining electronic databases of information on insured, insurance companies, and brokers. Brokers are able to view records for their client insureds as well as for the insurance companies from which they will receive quotes. Information is electronically populated into forms having a format which is transferable and readable by any of the parties involved.

US Patent Pub. No. 2014/0149316 for Rating system and method by inventor Tananbaum, filed Nov. 27, 2013 and published May 29, 2014, is directed to a rating method for Indexing and Rating a Defined Benefit type of Retirement Plan. The method provides a rating for the financial plan, with the rating based on the comparative average earnings value of the financial plan in relation to an equity return and/or a bond return. An algorithm computes the average earnings value in relation to the equity return or the bond return to determine the appropriate rating. The rating includes a scale of A through F, with “A” rating providing the best return, and “F” rating representing a poor return. The rating method derives the rating depending on whether the equity and bond returns are positive or negative. The rating method incorporates an annual cost of living value. The different participants include a contributor, a retired, a terminated, and an active participant. The market value of the financial plan's average earnings value can be computed.

U.S. Pat. No. 10,424,020 for System and method for evaluating defined contribution plans by inventor Kmak, et al., filed Aug. 9, 2013 and issued Sep. 24, 2019, is directed to a system and method for comparing retirement plans against a selected group of similar plans. In one embodiment, a computer system for evaluating a retirement plan comprises a computer server having a database comprising a plurality of data defining a plurality of characteristics of each of a plurality of retirement plans, software configured for identifying a subset of the plurality of retirement plans having characteristics comparable to characteristics of a selected retirement plan, software configured for permitting the selection of at least one report from a plurality of report types, and software configured for automatically generating the selected at least one report, where the at least one report comprises an evaluation of the characteristics of the selected retirement plan against the characteristics of the subset of the plurality of retirement plans.

US Patent Pub. 2021/0200759 for Systems and methods for data mining of historic electronic communication exchanges to identify relationships, patterns, and correlations to deal outcomes by inventors Lyons, et al., filed Aug. 12, 2020 and published Jul. 1, 2021, is directed to systems and methods for generating data metrics and relationship analysis from an organization's electronic communications archives include pre-processing the electronic communications into a consistent, workable format, including filtering the data to remove irrelevant messages. Machine learning models may be applied to support automatic identification of relevant message content for data analytics. The systems and methods may link the electronic communications with transaction records of a transactional platform and analyze the communications traffic in view of transactional patterns and outcomes. Communications between parties may be analyzed to identify timings and patterns, plus correlations between electronic communication patterns and business outcomes.

US Patent Publication No. 2018/0068274 for System and method for document processing by inventor Buffington, filed Sep. 8, 2017 and published Mar. 8, 2018, is directed to processing of information and documents, e.g., in analyzing financial plans such as retirement plans, presenting relevant information relating to a user, e.g., in 408 (b) (2) data, and tools for enhancing user understanding and decision making with respect to the same. Machine (e.g., optical recognition) of content of such forms and information is used in some aspects. Rankings and recommendations are automatically generated in other aspects.

U.S. Pat. No. 10,769,159 for Systems and methods for data mining for historic electronic communication exchanges to identify relationships, patterns, and correlations to deal outcomes by inventors Lyons, et al., filed Dec. 21, 2017 and issued Sep. 8, 2020, is directed to systems and methods for generating data metrics and relationship analysis from an organization's electronic communications archives include pre-processing the electronic communications into a consistent, workable format, including filtering the data to remove irrelevant messages. Machine learning models may be applied to support automatic identification of relevant message content for data analytics. The systems and methods may link the electronic communications with transaction records of a transactional platform and analyze the communications traffic in view of transactional patterns and outcomes. Communications between parties may be analyzed to identify timings and patterns, plus correlations between electronic communication patterns and business outcomes.

### SUMMARY OF THE INVENTION

The present invention relates to software platforms for collecting, aggregating, and analyzing the public filings of healthcare and pension plans from electronic databases to reverse-engineer client lists for the various service providers and brokers who compete within the industry ecosystem.

It is object of the present invention to identify potential customers and provide contact information for gatekeepers and decision makers of potential customers, including benefits brokers of the potential customers.

It is yet another object of the present invention to provide an end-to-end prospecting tool for third-party administrators and other plan professionals.

In one embodiment, the present invention includes a system for aggregating and analyzing data from a multiplicity of websites, and syncing the data with a customer relationship management (CRM) platform, including a remote server including a processor, a memory, and at least one database and a software application on an electronic device including a processor and a memory, wherein the remote server is in network communication with the electronic device, wherein the remote server is configured to retrieve data from at least one government website, wherein the remote server is configured to analyze the benefits disclosure documents and normalize data extracted from the benefits disclosure documents using a natural language processing (NLP) algorithm, wherein the remote server is configured to receive social media data from a web scraper or a web crawler, wherein the web scraper or the web crawler is configured to retrieve contact information from at least one social media profile for a contact on at least one social media website and a social media profile uniform resource indicator (URL) for the contact based on the data retrieved by the remote server from the at least one government website, wherein the electronic device is configured to display a graphical user interface (GUI) for the software application, wherein the GUI provides search functionality of the at least one database on the remote server for benefits broker data, employer data, and service provider data, wherein the GUI is configured to display search results for a broker, an employer, and a service provider, and wherein the GUI is configured to display the contact information for the contact and a hyperlink to the URL for the contact, wherein the contact includes a contact for a broker, a contact for an employer, or a contact for a service provider.

In another embodiment, the present invention includes a method for aggregating and analyzing data from a multiplicity of websites, and syncing the data with a customer relationship management (CRM) platform, including a remote server including a processor, a memory, and at least one database retrieving data from at least one government website, the remote server analyzing the benefits disclosure documents and normalizing data extracted from the benefits disclosure documents using a natural language processing (NLP) algorithm, the remote server receiving social media data from a web scraper or a web crawler, the web scraper or the web crawler retrieving contact information from at least one social media profile for a contact on at least one social media website and a social media profile uniform resource indicator (URL) for the contact based on the data retrieved by the remote server from the at least one government website, an electronic device including a processor, a memory, and a software application in network communication with the remote server displaying a graphical user interface (GUI) for the software application, wherein the GUI provides search functionality of the at least one database on the remote server for benefits broker data, employer data, and service provider data, the GUI displaying search results for a broker, an employer, and a service provider, and the GUI displaying the contact information for the contact and a hyperlink to the URL for the contact, wherein the contact includes a contact for a broker, a contact for an employer, or a contact for a service provider.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of a prospecting platform according to one embodiment of the present invention.

FIG. 2A is a schematic diagram of a prospecting platform for providing data for a provider master database according to one embodiment of the present invention.

FIG. 2B is a schematic diagram of a prospecting platform for providing data for a broker master database according to one embodiment of the present invention.

FIG. 3A illustrates a first part of a flow diagram of a prospecting platform according to one embodiment of the present invention.

FIG. 3B illustrates a second part of a flow diagram of a prospecting platform related to first part of the flow diagram shown in FIG. 3A.

FIG. 3C illustrates a third part of a flow diagram of a prospecting platform related to the first part and the second part of the flow diagram shown in FIGS. 3A-3B.

FIG. 3D illustrates a fourth part of a flow diagram of a prospecting platform related to the first part, the second part, and the third part of the flow diagram shown in FIGS. 3A-3C.

FIG. 3E illustrates a fifth part of a flow diagram of a prospecting platform related to the first part, the second part, the third part, and the fourth part of the flow diagram shown in FIGS. 3A-3D.

FIG. 3F illustrates a sixth part of a flow diagram of a prospecting platform related to the first part, the second part, the third part, the fourth part, and the fifth part of the flow diagram shown in FIGS. 3A-3E.

FIG. 4 illustrates a graphical user interface for conducting a broker search according to one embodiment of the present invention.

FIG. 5 illustrates a graphical user interface of a list of office locations for a broker according to one embodiment of the present invention.

FIG. 6 illustrates a graphical user interface of a list of clients for a selected office location of a broker according to one embodiment of the present invention.

FIG. 7 illustrates a graphical user interface of an employer profile according to one embodiment of the present invention.

FIG. 8A illustrates a graphical user interface of a contacts page for a selected office location of a broker according to one embodiment of the present invention.

FIG. 8B illustrates a custom prospect list GUI according to one embodiment of the present invention.

FIG. 8C illustrates a CRM integration interface for integrating custom prospect lists with or exporting custom prospect lists to a CRM software platform according to one embodiment of the present invention.

FIG. 8D illustrates a schematic of CRM platform object structure according to one embodiment of the present invention.

FIG. 9 illustrates an alternative graphical user interface for conducting a broker search.

FIG. 10A illustrates a list of fee-paying clients for a broker according to one embodiment of the present invention.

FIG. 10B illustrates a book of business for a broker according to one embodiment of the present invention.

FIG. 11 illustrates a client list for a third-party administrator according to one embodiment of the present invention.

FIG. 12 illustrates a client list for a broker according to one embodiment of the present invention.

FIG. 13 illustrates a client list for a third-party administrator according to one embodiment of the present invention.

FIG. 14A illustrates a graphical user interface for conducting a broker search according to one embodiment of the present invention.

FIG. 14B illustrates a graphical user interface for conducting a broker search according to one embodiment of the present invention.

FIG. 15 illustrates a graphical user interface of an employer profile according to one embodiment of the present invention.

FIG. 16 illustrates a graphical user interface of a contacts list for an employer according to one embodiment of the present invention.

FIG. 17A illustrates a graphical user interface of a history of active participants in plans for an employer according to one embodiment of the present invention.

FIG. 17B illustrates a graphical user interface of a history of broker commissions for an employer according to one embodiment of the present invention.

FIG. 17C illustrates a graphical user interface of a history of carrier premiums for an employer according to one embodiment of the present invention.

FIG. 18 illustrates an alternative GUI displaying information about a pension plan for a company.

FIG. 19 illustrates a graphical user interface of fees paid to service providers according to one embodiment of the present invention.

FIG. 20 illustrates a graphical user interface for conducting a service provider search according to one embodiment of the present invention.

FIG. 21 illustrates a graphical user interface of a client list for a service provider according to one embodiment of the present invention.

FIG. 22 illustrates a graphical user interface of a synchronization screen with a profile of a customer relationship management (CRM) profile according to one embodiment of the present invention.

FIG. 23A illustrates a graphical user interface of a mapping screen for broker data from customer relationship management (CRM) information according to one embodiment of the present invention.

FIG. 23B illustrates a graphical user interface of a mapping screen for office data from customer relationship management (CRM) information according to one embodiment of the present invention.

FIG. 23C illustrates a graphical user interface of a mapping screen for contact data from customer relationship management (CRM) information according to one embodiment of the present invention.

FIG. 24 is a schematic diagram of a system of the present invention.

### DETAILED DESCRIPTION

The present invention is generally directed to lead generation platforms for service providers involved with the administration and management of employer-sponsored healthcare and pension plans.

It is one object of the present invention to provide an end-to-end prospecting tool for benefits vendors, third-party administrators and other plan professionals.

It is another object of the present invention to provide dynamic graphical user interfaces including information about service provider client lists for healthcare and pension plans.

In one embodiment, the present invention includes a system for aggregating and analyzing data from a multiplicity of websites, and syncing the data with a customer relationship management (CRM) platform, including a remote server including a processor, a memory, and at least one database and a software application on an electronic device including a processor and a memory, wherein the remote server is in network communication with the electronic device, wherein the remote server is configured to retrieve data from at least one government website, wherein the remote server is configured to analyze the benefits disclosure documents and normalize data extracted from the benefits disclosure documents using a natural language processing (NLP) algorithm, wherein the remote server is configured to receive social media data from a web scraper or a web crawler, wherein the web scraper or the web crawler is configured to retrieve contact information from at least one social media profile for a contact on at least one social media website and a social media profile uniform resource indicator (URL) for the contact based on the data retrieved by the remote server from the at least one government website, wherein the electronic device is configured to display a graphical user interface (GUI) for the software application, wherein the GUI provides search functionality of the at least one database on the remote server for benefits broker data, employer data, and service provider data, wherein the GUI is configured to display search results for a broker, an employer, and a service provider, and wherein the GUI is configured to display the contact information for the contact and a hyperlink to the URL for the contact, wherein the contact includes a contact for a broker, a contact for an employer, or a contact for a service provider.

In another embodiment, the present invention includes a method for aggregating and analyzing data from a multiplicity of websites, and syncing the data with a customer relationship management (CRM) platform, including a remote server including a processor, a memory, and at least one database retrieving data from at least one government website, the remote server analyzing the benefits disclosure documents and normalizing data extracted from the benefits disclosure documents using a natural language processing (NLP) algorithm, the remote server receiving social media data from a web scraper or a web crawler, the web scraper or the web crawler retrieving contact information from at least one social media profile for a contact on at least one social media website and a social media profile uniform resource indicator (URL) for the contact based on the data retrieved by the remote server from the at least one government website, an electronic device including a processor, a memory, and a software application in network communication with the remote server displaying a graphical user interface (GUI) for the software application, wherein the GUI provides search functionality of the at least one database on the remote server for benefits broker data, employer data, and service provider data, the GUI displaying search results for a broker, an employer, and a service provider, and the GUI displaying the contact information for the contact and a hyperlink to the URL for the contact, wherein the contact includes a contact for a broker, a contact for an employer, or a contact for a service provider.

None of the prior art discloses a software platform which reverse engineers client lists of brokers and fees paid by those clients through automatically collecting and extracting data from online data sources, utilizing natural language processing (NLP) algorithms to aggregate and normalize healthcare provider data, broker data, third-party administrator data, and other plan professionals data from the online data sources, and displaying competitor lists and fees charged by competitors via a dynamic graphical user interface (GUI). Furthermore, none of the prior art discloses utilizes web crawlers to gather social media data to match individual broker office locations, and even individual broker contacts, associated with specific clients.

In 2021, there were over 100,000 healthcare plans, 600,000 Employee Retirement Income Security Act of 1974 (ERISA) benefit plans and 40,000 providers of healthcare and benefit plans. Identifying service provider client lists and fees charged to service provider clients in real-time is practically impossible due to the sheer volume of information. Benefits vendors, insurance carriers, third-party administrators, brokers, and other plan professionals associated with the provision of services relating to healthcare and pension plans struggle to obtain up to date information on their competitors, including client lists and fees charged by competitors to their clients.

One of the reasons that benefits vendors, insurance carriers, third-party administrators and other plan professionals have difficulty identifying opportunities is the current lack of data aggregation and normalization as well as the current lack of graphical user interface functionality for organizing, sorting and presenting this data. The Form 5500 series allows employers who sponsor an employee benefit plan for their employees to satisfy annual reporting requirements under Title I and Title IV of ERISA and under the Internal Revenue Code. The Form 5500 Annual Return/Report provides valuable information on ERISA-covered, private sector employer-sponsored benefits plans and their operation, funding, assets, and investments. The Department of Labor provides the availability to search by plan name, plan sponsor, employer identification number (EIN), and filing identification. The Form 5500 data is presented as a standard tax document in either a portable document format (PDF) or as a spreadsheet (ex: EXCEL or Comma-Separated Values (CSV) files). However, this information is currently siloed, and there is not currently a system for aggregating and normalizing this information to provide client lists of service providers and fees charged by the service providers to the clients based on the data. Thus, there is a need for capturing data from these forms and transforming the data so it is easily sortable and analyzable. Additionally, the forms often contain errors or different iterations of information such as corporate names that affect the data accuracy, so there is a need to detect and correct errors and inconsistencies.

Another problem is that many markets are regionally based so benefits vendors, insurance carriers, third-party administrators and other plan professionals tend to have a majority of their clients in a particular geographic region. Expanding into new geographic regions can be difficult, given the high retention rates observed across the industry and relationship-centric sales cycles. Thus, having a data-driven prospecting platform can be critical to gaining traction in a new market. Further, a platform that is configured to provide rapid intelligence on the major competitors in new geographic regions and a list of their clients and fees paid can be hugely valuable when seeking market share gains.

Yet another problem faced by benefits vendors, insurance carriers, third-party administrators and other plan professionals is the lack of information regarding service providers for healthcare and benefits plans, such as the names and contact information of attorneys, accountants, actuaries, providers of payer services, and other similar individuals. Approximately fifty percent of employees in the United States are enrolled in self-funded healthcare plans, and this represents a large market for which quick access to information provides a competitive edge for benefits vendors, insurance carriers, third-party administrators and other service providers. Therefore, there is a need for a prospecting platform that is configured to capture contact information for relevant points of contacts or gatekeepers to provide an end-to-end prospecting platform.

Referring now to the drawings in general, the illustrations are for the purpose of describing one or more preferred embodiments of the invention and are not intended to limit the invention thereto.

Companies are required to fill out forms related to their healthcare and other similar benefit plans (e.g. Form 5500, Form 990). These forms include information pertaining to accountants, actuaries, third-party administrators, attorneys, insurance carriers, trustees of the insurance and benefits plan, and other service providers. The data is shown on the publicly available forms, however, there is no current system that captures, aggregates, normalizes, and displays this data in a manner that provides for benefits vendors, insurance carriers, third-party administrators and other service providers to accurately determine which clients their competitors are servicing and the fees their competitors charge to their clients.

In one embodiment, the present invention provides an end-to-end prospecting system for benefits vendors, insurance carriers, third-party administrators and other service providers to determine potential clients and client lists of competitors. The system includes at least one remote server including at least one database and a software platform. The at least one remote server and the at least one software platform are in network communication. The software platform includes an interactive software application to aid benefits vendors, insurance carriers, third-party administrators and other service providers in prospecting and organizing information relating to competitors and clients of competitors.

The present invention provides a software platform for employee benefits vendors which provide or support the provisioning of benefits for employees, including healthcare, wellness, and retirement benefits.

Employee benefits vendors typically reach employers directly or through benefits brokers, companies which have standing relationships with decision-making units within corporate human resources (HR) departments. HR departments often rely on benefits brokers for options for employee benefits plans, including wellness, healthcare, and retirement plans. Given the existing relationships between benefits brokers and HR departments, benefits vendors often find it most efficient to reach employer end customers through benefits brokers. Reaching employer end customers through benefits brokers also provides for scalability given that benefits brokers typically have relationships with multiple employers and act as a lead source for additional employer customers for the benefit vendors.

While selling through benefits brokers typically provides for the highest return on energy invested in outreach, some employers do not have a longstanding relationship with benefits brokers or do not even have a benefits broker. Other circumstances lead to difficulties for benefits providers to reach employers through benefits brokers. Accordingly, it is advantageous for benefits providers to be able to contact employers directly.

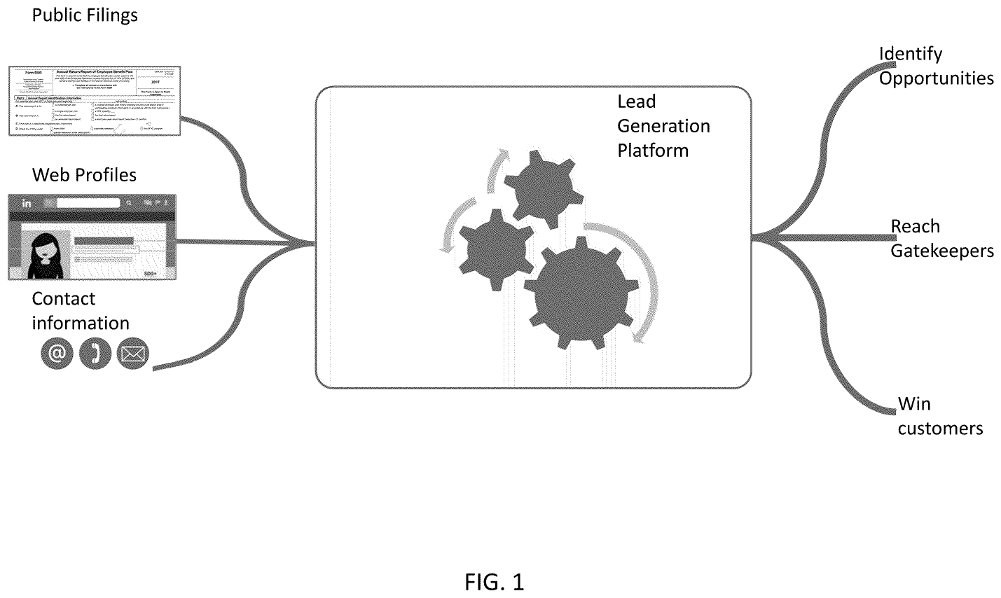

In one embodiment, as shown in FIG. 1, the present invention is configured to retrieve data from a database including a collection of Form 5500 (and optionally Form 990 documents), and at least one social media website such as LINKEDIN. The data from Form 5500 (and/or Form 990) documents are obtained from webpages in one embodiment. The present invention is operable to obtain contact data for gatekeepers such as brokers or plan trustees from at least one social media website profile, including at least one email address, mailing address, or phone number. Alternatively, the system is configured to obtain contact data from a web-based source using a web scraping tool. For example, and not limitation, the present invention is configured to identify an email address for a gatekeeper via a company's website. In one embodiment, the web scraping tool is operable to determine a website associated with a company, determine the desired contacts at the company, create possible permutations of email addresses for the desired contacts based on the name of the desired contacts and the domain name of the website associated with the company, and check the possible permutations of email addresses for the desired contacts using an email checker or a similar tool to determine valid email addresses for the desired contacts at the company. The present invention extracts data of gatekeepers from Form 5500 (and/or Form 990) documents and searches for these gatekeepers on a social media website, extracts the contact information for these gatekeepers, and displays the contact information for these gatekeepers in the GUI. If no gatekeepers are listed in Form 5500 documents (or Form 990 documents), the platform analyzes social media profiles associated with a plan or potential client, and recommends contact information based on job title or other information included in the social media profile. For example, employees with technical job titles such as data scientist or programmer are generally excluded and employees with job titles such as sales agent are recommended by the present invention. The present invention is operable to provide scores for contact information in one embodiment, with a higher score indicating a higher likelihood that the person is likely a gatekeeper. In one embodiment the present invention is operable to first search a social media website (such as LINKEDIN), and upon finding no matching results for a person of interest, search one or more additional websites for contact information. In one embodiment, the one or more additional websites include other repositories of contact information, such as voter information websites, secretary of state websites, or other social media websites. For example, and not limitation, the data is obtained via a web crawler, a web mining tool, a web scraper, and other methods of data extraction. In some cases, the data is purchased from third-party vendors. The system is further configured to use natural language processing to analyze the retrieved data and transfer the analyzed data to a data repository or database. Using natural language processing and other artificial intelligence algorithms, the system is configured to parse text in the documents to identify relevant information for healthcare and other benefits plans, and information about service providers associated with those plans. For example, and not limitation, the present invention is configured to identify a company's name, a company's benefit plan(s), the broker(s), the third-party administrator, other service providers, fees paid to each third-party and other services providers, commissions paid to brokers, number of participants enrolled in the plan, the type of plan, and the specific benefits offered by plan. The system is further configured to display the data via a GUI. Advantageously, the system is configured to filter the data based on entity type, plan type, number of participants, and geographic region to decrease the number of plans that a benefits vendor, insurance carrier, third-party administrator or other plan professional would need to review. Additionally, the system is further configured to receive a selection of a broker. The system is configured to display a broker's contact information (e.g. phone number, email, LINKEDIN profile, and office address). The system is also configured to display a broker's entire client list and filter the broker's client list by entity type, size of market participants, plan type, and other similar factors. The system is also configured to construct and display client lists for specific service providers using machine learning, which is helpful to obtain competitive intelligence. The present invention is configured for real-time data extraction with the third-party data sources and to update the data displayed via the GUI in real-time. Advantageously, this enables the present invention to provide real-time representation of a broker's, service provider's and third-party administrator's client list.

Additionally, the present invention is configured to capture and analyze data for tax-exempt organizations from a separate web page. The present invention is the only platform that captures data from a collection of Form 990 data and provides for searching and sorting this data, as well as linking Form 990 data to data obtained from LINKEDIN and other social media websites. This means that the present invention is configured to capture, filter, and analyze data for tax-exempt organizations. In contrast to typical corporate plan sponsors, these organizations generally do not purchase benefit plan services through benefits brokers, so the present invention is configured to display the names and titles of plan trustees (which are typically the gatekeepers for such organizations) and other similar points of contact for each tax-exempt organization. Advantageously, this allows a benefits vendor, insurance carrier, third-party administrator and other service providers to know who to directly contact.

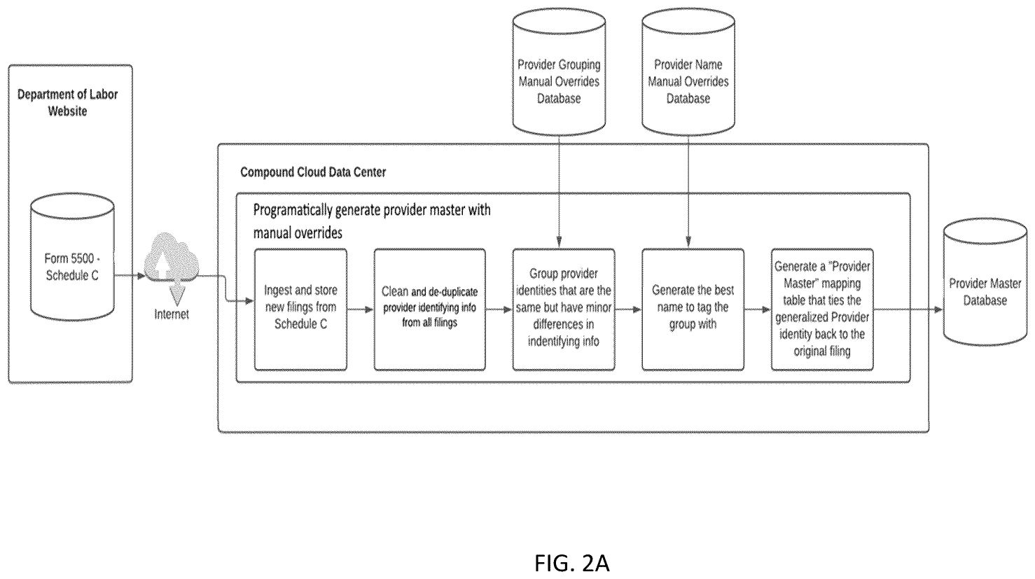

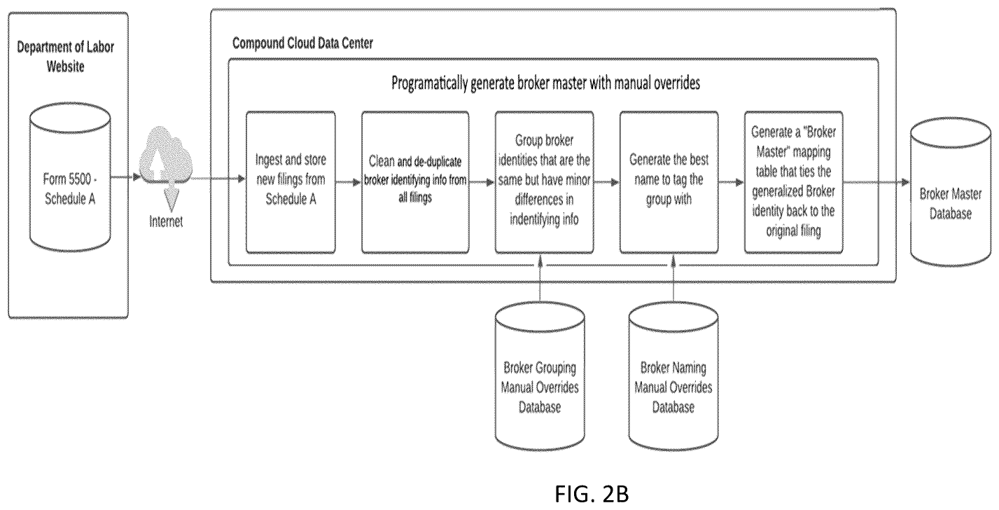

In one embodiment, as shown in FIGS. 2A-B, the present invention is configured to create a service provider database and a broker database. The present invention includes a platform that is configured to receive information via network communication related to Form 5500 documents, Form 990 documents, and other web sources including social media platforms (e.g. LINKEDIN). The platform is configured to store the received data. Additionally, the platform is configured to automatically clean the received data, including removing duplicate provider identifying information and removing non-descriptive words such as articles (“the”, “of”, etc.). The system is further configured to identify provider and broker identities that have similar names and to correct errors using NLP. In one embodiment, a rules engine processes names of clients and service providers, groups clients, and/or service providers that are connected to the same or similar clients and/or service providers, and stores these associations in a database. In one embodiment, the system is configured to receive override input to correct errors. The system is configured to generate a table identifying each provider and the corresponding plan information and a table for each broker and the corresponding plan information from the Form 5500 data and the Form 990 data. The system is then configured to store the information in a provider database and a broker database.

In another embodiment, the software platform includes a web crawler, an analytics engine, an artificial intelligence engine, and a software application. The software platform is in network communication with a third-party data source. For example, and not limitation, the third-party data source includes the United States Department of Labor website. In another embodiment, the third-party data source includes a social media platform (e.g. LINKEDIN). In one embodiment, the web crawler programmatically receives a broker company name and/or address from a database of broker names in the database and/or via manual input from a user or administrator, and automatically utilizes the name and/or address to retrieve a social media URL associated with the company and/or address via a search engine (e.g., GOOGLE, BING, etc.) search and/or a search directly on one or more social media sites. The web crawler is then able to retrieve one or more data points regarding the company via the social media link, including but not limited to a company website URL, a company name (legal entity and/or common name), a list of office locations, a list of employees, corporate leadership names, and/or other information. A machine learning module of the software platform then automatically matches the web profile to a company listed in the database of the software platform. Preferably, the machine learning module matches information gathered from the web crawler retrieval with information already entered in the database for the company, confirming that the information gathered concerns the correct company. The machine learning module is then able to add gathered information for the company from the web crawler to the database.

In one embodiment, a company URL found by the web crawler or otherwise received by the platform and/or job titles associated with the company found by the web crawler or otherwise received by the platform are programmatically passed to one or more third party contact vendors via one or more application programming interfaces (APIs). The platform then automatically receives a curated set of contacts for each broker via the APIs. In one embodiment, the social media or company website URLs associated with each contact or company are periodically (e.g., every week, every month, every six months, etc.) reexamined by the web crawler to identify changes in the contact information (e.g., job changes). In one embodiment, when a job change is detected by the web crawler, a notification is automatically transmitted to one or more profiles monitoring the change. In one embodiment, when a job change is detected, the platform automatically utilizes the one or more contact vendor APIs to retrieve new contact information (e.g., email address, phone number, etc.) for the new or changed contact.

The web crawler is configured to capture data from at least one document from the third-party data source. The third-party data includes name, location, company, occupation, and other related information. The at least one document includes Form 5500 series documents (e.g. 5500-SF, 5500-EZ) and/or Form 990 Series (e.g. Form 990-N, 990-EZ, 990-PF) documents. Data extracted from Form 5500 documents includes, but is not limited to, how many employees are enrolled in benefit plans, which benefits are offered, the carriers that wrote the insurance policies (and the premiums they collected), and the brokers who placed the insurance policies (and the commissions they collected). In another embodiment, the web crawler is configured to capture data from at least one website, such as a company website or other public web pages. By configuring the web crawler to capture data from at least one website, additional benefits info that are not be reported on Form 5500s such as voluntary benefits and other employee perks that fall outside of traditional medical insurance are operable to be captured. While this information is not reported on Form 5500 documents, this information is still part of an employee's comprehensive benefits package. The web crawler is operable to transfer the data to the artificial intelligence engine, where the third-party data is tagged and aggregated. The aggregated data is transferred to the analysis engine, where the aggregated data is analyzed for trends, patterns, and/or correlations in the aggregated data. The raw data, aggregated data, and analyzed data are store in the database. The software platform is further in network communication with at least one remote device. For example, and not limitation, the at least one remote device includes a computer, a laptop, a mobile phone, and other similar devices. The software platform is configured to generate a report using the analyzed data. The system is further configured to transmit the report to the at least one remote device and display the report via a GUI.

This Form 5500 information is therefore able to be used to create a superset of a set of all office locations across a given broker, where the superset includes offices mentioned on the broker's company social media profile (e.g., LINKEDIN profile). After the list of all offices is retrieved, the city, state, and street address for the office are automatically transmitted to a “geocoder” (e.g., a third party geolocation API) to determine and retrieve latitude/longitude coordinates for each office. In one embodiment, the third party geolocation API is also used to clean up the city and/or state naming conventions used as well. Locations of every employer determined to be working with a specific broker (e.g., based on Form 5500 information) are determined based on web-crawler retrieved and analyzed information from Form 5500s for the employer, with the locations then automatically passed to the third-party geolocation API to gather latitude/longitude coordinates. The employers are then able to be associated with the most likely broker offices based on calculated distance between the coordinates of the employer and each of the list of broker office locations.

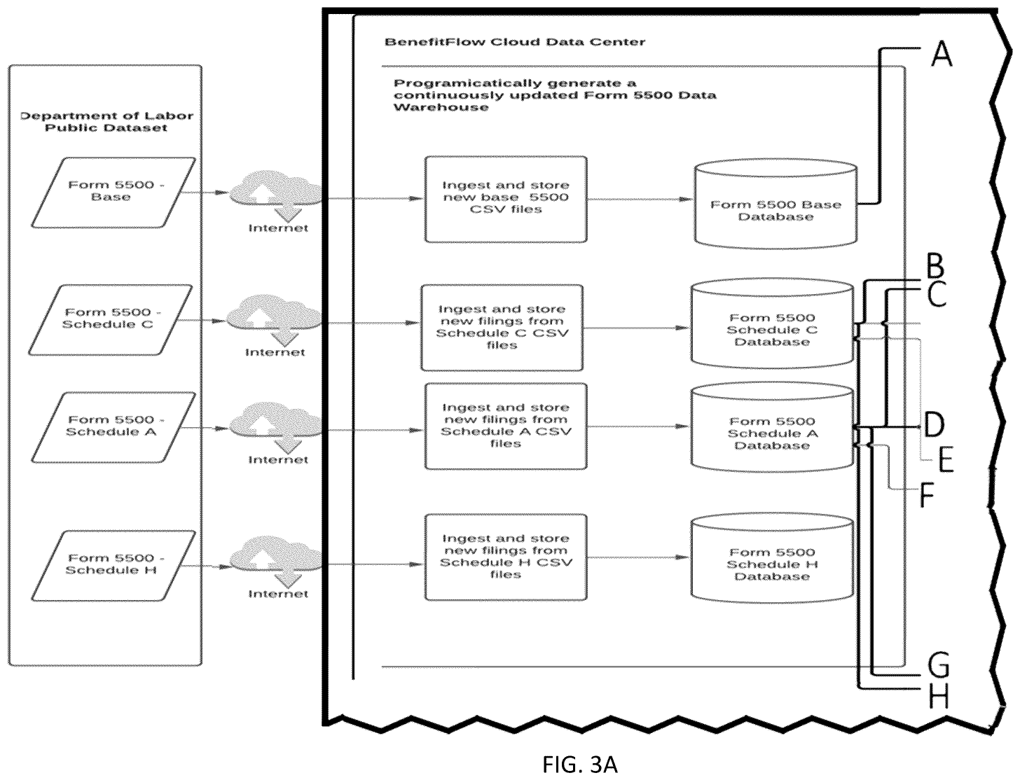

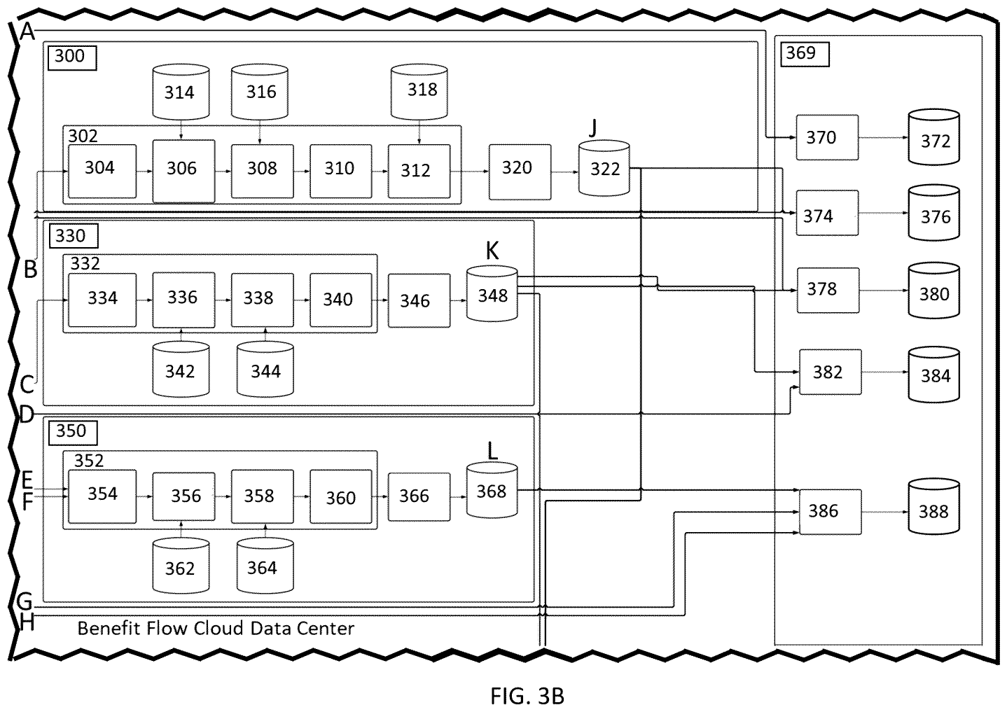

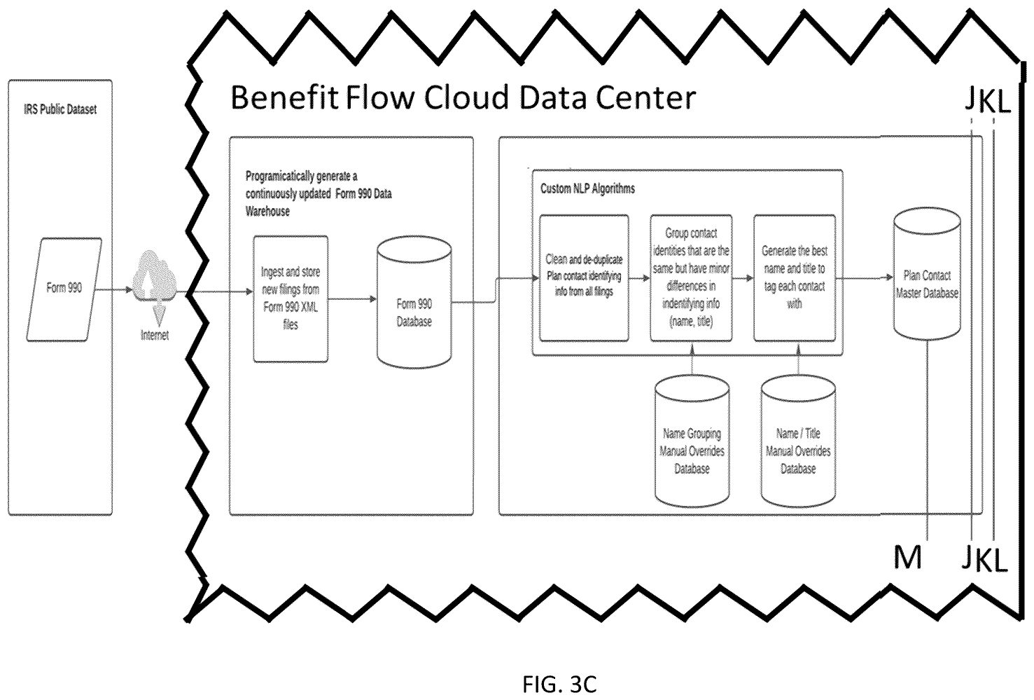

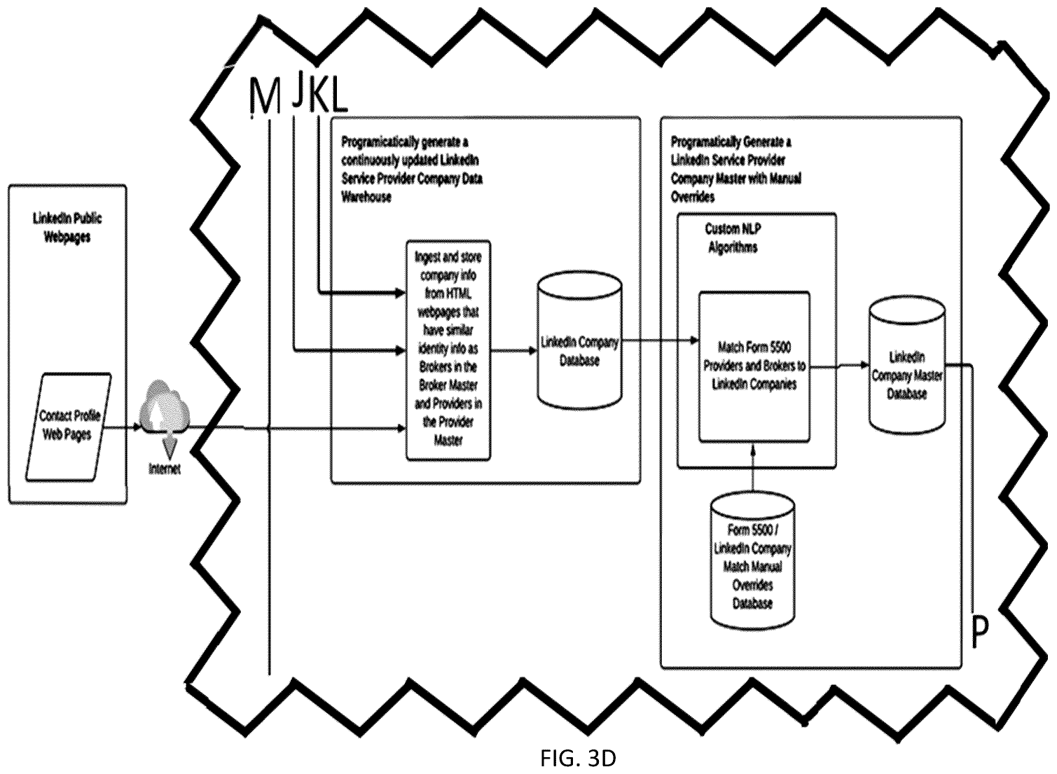

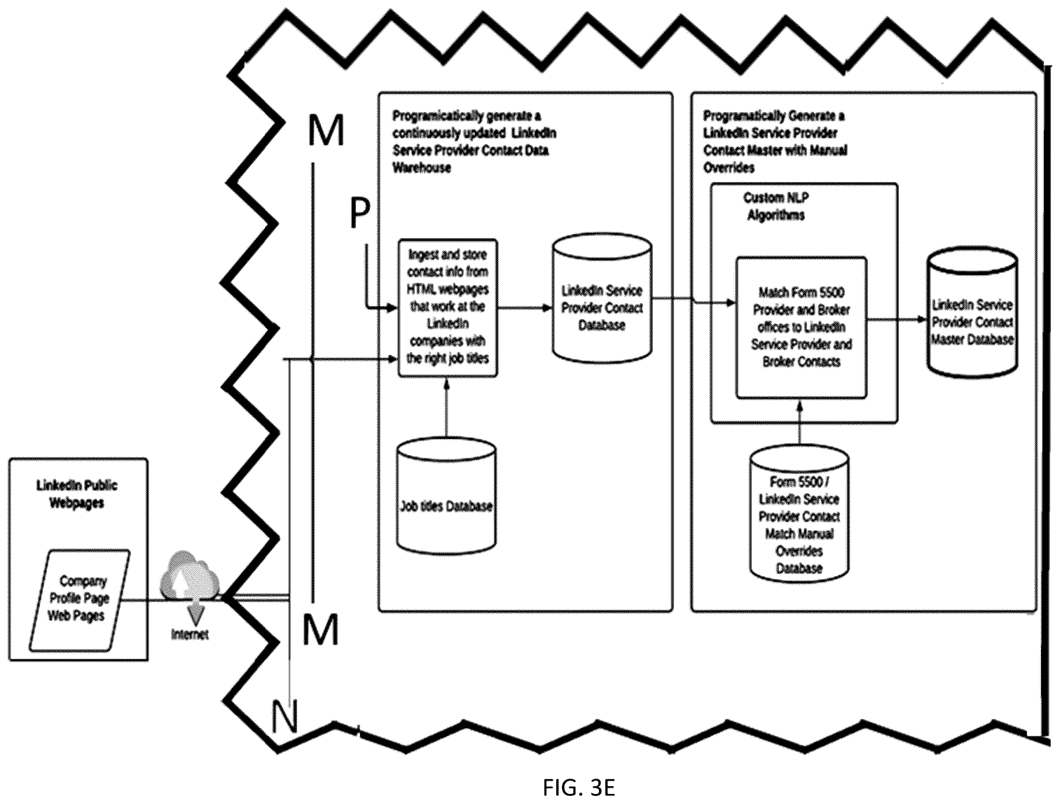

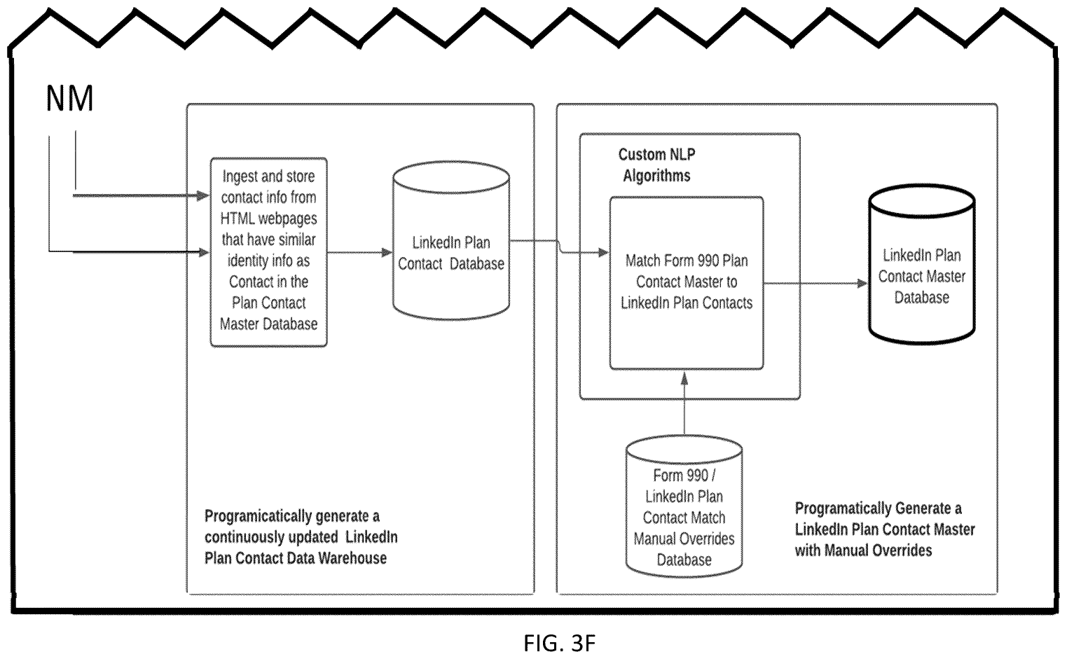

In another embodiment, the present invention includes a prospecting platform for benefits vendors, insurance carriers, third-party administrators and other service providers. In one embodiment, as shown in FIG. 3A, the prospecting platform receives Form 5500 Schedule A, Schedule H, Schedule C, and other schedules of Form 5500 data via the Internet. Alternatively, the prospecting platform is configured to receive the Form 5500 data via other types of network communication. The prospecting platform is configured to store the Form 5500 data in a data center and to generate an updated Form 5500 data warehouse. The prospecting platform continuously receives and stores new filings for Form 5500 CSV data. The prospecting platform then stores the data in a separate database for each Form 5500 schedule. As shown in FIG. 3B, the Form 5500 data is then cleaned using natural language processing algorithms. Specifically, the present invention provides for programmatically generating a service provider master with manual overrides 300. A first set of custom NLP algorithms 302 are used to clean and de-duplicate service provider identifying info from all filings 304, group service provider identities that are the same but have minor difference in identifying information (including name, location, and EIN) 306, generate the best name to tag the group with 308, generate the best capitalization 310, and classify the service provider type (TPA, lawyer, network, consultant, etc.) 312. The service provider grouping manual overrides database 314 is operable to provide input to grouping service provider identities that are the same but have minor differences in identifying information 306 and override any automatically generated data from the NLP algorithms. Examples of tasks performed by the NLP algorithms 302 include automatically identifying common abbreviations for common words (e.g., “Assn” for “Association,” etc.), such that each data source searched by the web crawler includes common nomenclature for companies and thus companies are able to be properly de-duplicated. In one embodiment, the NLP algorithms also detect common misspellings of specific words and automatically correct those misspellings. Once broker names are cleaned up and misspellings are corrected, a custom machine learning module automatically groups duplicate entries into a single entry, allowing searches for a specific company on the platform to only show one result for the company on the platform with all the info about that company, rather than a plurality of results with information divided between them. This machine learning module utilizes a combination of matching location (e.g., city and state) for each office location and Levenshtein distance for fuzzy matching to spot duplicates and group those duplicate entries together.

Additionally, the service provider name manual overrides database 314 is operable to provide input to generating the best name to tag the group with 308 and override any automatically generated data from the NLP algorithms. The service provider type manual overrides database 316 is operable to provide input to classifying the service provider type 312 and override any automatically generated data from the NLP algorithms. The output from the NLP algorithms includes generation of a “Service Provider Master” mapping table that ties the generalized service provider identity back to the original filing 320; this information is included in the service provider master database 322.

The present invention provides also provides for programmatically generating a broker master with manual overrides 330. A second set of NLP algorithms 332 are used to clean and de-duplicate broker identifying information from all filings 334, group broker identities that are the same but have minor differences in identifying information (including name and location) 336, generate the best name to tag the group with 338, and generate the best capitalization 340.

In one embodiment, the present invention includes at least one web crawler or web scraper configured to automatically search at least one search engine, database, or other computer environment to determine a list of broker office locations. In one embodiment, the list of brokers for which the system searches are provided to the web scraper and/or web crawler and the system will then utilize machine learning to match one or more social media profiles or company websites to the names of the brokers provided to automatically determine one or more broker office locations for the broker based on the information on those social media profiles or company websites. In one embodiment, this determination is made based on openly provided information on the website or profiles, but the artificial intelligence in conjunction with the web crawler and/or web scraper is also able to determine locations of the company based on other information, such as geotagged data associated with posts by the company, references to state or city of location in the terms of service on the company website, and/or other information. In one embodiment, the artificial intelligence in conjunction with the web crawler and/or web scraper is able to determine likely broker office locations based on publicly available locations of known employees or executives associated with the broker (determined through, e.g., the company website or social media profile, such as a LINKEDIN profile). In this manner, the system develops a list of one or more office locations for each broker. In one embodiment, the determination of a list of brokers or broker office locations is done based on information received from a CRM platform associated with the consumer profile.

In one embodiment, the platform of the present invention syncs information for one or more contacts (e.g., producers, account managers, vendor specialists, etc.) from at least one device, social media profile, or CRM profile associated with a user profile. The platform then automatically associates contacts with broker office locations or employer office locations to which they belong. If an office location is determined for a particular contact and that office location is not an entry in the database of the platform associated with the broker or employer, the platform automatically generates an office location child account associated with the parent account of the broker or employer controlling that office location. In one embodiment, the platform automatically transmits a confirmation message to the parent account to confirm that a child account should be generated, while, in another embodiment, no confirmation message is transmitted.

Although overriding information is accomplished manually according to one embodiment of the present invention, another embodiment of the present invention provides for automatically overriding information. In one example, a broker office location tied to a given employer is overridden or changed using one or more algorithms. Employers must submit details regarding brokers used during the relevant reporting period in Schedule A of the Form 5500, including addresses of brokers who service the employer. Brokers typically have multiple offices, including a headquarters address and distributed office locations which service employers. Often, the headquarters address of the broker is included in the form by the employer instead of the address of the actual office of the broker who is servicing the employer. In one embodiment, the present invention automatically overwrites a headquarters address associated with a broker that is provided by an employer on the form with the address of an office of the broker that is closest geographically to the address of the employer, as the office of the broker geographically closest to the employer is statistically the broker office most likely to service the employer.

In one embodiment, enrichments (i.e., updates) are automatically pushed to a CRM profile associated with a user profile when information regarding the user profile changes and/or information connected to the CRM profile changes (e.g., if a contact listed on the CRM profile begins working at a new company, gets a new email address, gets a new job title, moves locations, etc.). In one embodiment, these changes are detected based on periodic and regular scrapes of one or more websites or social media profiles by the at least one web crawler or web scraper. In one embodiment, the platform is operable to receive a preferred setting regarding intervals at which such scrapes are taken so as to provide updates. In one embodiment, if any information is changed on the platform for an employer, such as the benefits date, who their benefits broker is, how many employees they have, or other changes, these updates are automatically pushed to the CRM platform. This provides a sort of “auto-pilot” feature that keeps CRM data up-to-date. In one embodiment, a database associated with the platform automatically saves previous versions of the system after each change and saves a timestamp associated with each identified change. In one embodiment, a notification message, is automatically transmitted to one or more user profiles when particular changes are made to a particular broker, employer, or other profile (e.g., when an employer chooses a different broker, when a new person is hired for a particular position for a particular employer, when a contact changes jobs, etc.). In one embodiment, the trigger conditions for such notification messages are set by each user profile, while in another embodiment, an artificial intelligence module automatically determines likely trigger conditions for each particular user profile based on past user profile activity, settings by similar user profiles, or other insights.

In one embodiment, the platform saves signals and timestamps associated with those signals, where the signals are particular types of changes that occur on the platform (i.e., an individual changes jobs, employers choosing different brokers, new people hired). These signals are able to be used as search criteria for users of the platform, such that, by way of example and not limitation, a user is able to search for recent examples of specific signals, such as people who have changed jobs in the past six months. The platform further provides for each for particular signals within a particular time period (i.e., between June and December of 2021). These signals are further able to be used as information for an artificial intelligence module of the system that is able to provide insights for users of the platform. For example, the artificial intelligence module is able to suggest employers to target for brokers based on a list of employers for whom individuals in particular positions have recently changed. In this example, the signal is essentially able to act as a filter for employers that recently hired, for example, a new benefits broker.

The closest geographic address of a broker office to the employer address is determined in one embodiment by first creating a database of every unique address that's reported for a given broker across every Form 5500 Schedule A filing, the broker's company website, and the broker's LinkedIn company page. Every unique address is normalized to remove duplicates (e.g., separate entries of 101 Main Street, Washington, DC and 101 Main St., Washington, DC are normalized to create one listing, such as 101 Main Street, Washington, DC). In one embodiment, a headquarter address of a broker is identified in the database and is automatically overwritten with a local broker office based on the proximity of the geographic location to the local broker office. After a database including normalized addresses for brokers is created, distances between every unique broker office address and the address of the employer is determined. In one embodiment, the distances are determined by integrating features of a mapping program such as GOOGLE MAPS, APPLE MAPS, or ARCGIS with the database. Alternatively, a geocoding program is utilized to determine the latitude and longitude of each broker address and the employer address, and distances are calculated using an online mapping program. In another embodiment, the zip codes of the broker addresses and the employer address are determined and a distance between the zip codes, such as a distance between the center point or the approximate center point of the zip codes, is determined. After the distances between the employer address and each broker office location are determined, the shortest distance corresponding to the geographically closest broker location is selected along with the corresponding geographically closest broker location.

Additionally, a weighting formula is operable to be utilized when determining a broker office which likely services an employer. Although a geographically closest broker office is most likely to service an employer, sometimes brokers have a very small office (as determined by a number of key contacts working for the broker with an address that matches the very small office address) that is in close proximity (e.g., 5 miles) from a very large office. In these scenarios, the very large office is more likely to service the employer based on the size of the very large office. Accordingly, in one embodiment, the size of the office as measured by the key contacts working in that office is used as a factor in determining which broker office to assign to an employer. By way of example and not limitation, an algorithm for determining a score for determining which broker office to assign to an employer includes multiplying the distance in miles between the employer address and the broker office by the number of key contacts in the broker office and dividing by the square of the distance in miles between the employer address and the broker office. In this example, a broker office that has two key contacts and is ten miles from the employer address would receive a score of (10×2)/100=0.2. A broker office that has ten key contacts and is fifteen miles away from the employer address would receive a score of (15×10)/225=0.67. A much larger office that is one hundred miles away from the employer address that has fifty employees would receive a score of (100*50)/10,000=0.5. Advantageously, this algorithm accounts for the geographic distance between the employer office and the broker offices in addition to the size of the broker offices when determining the broker office most likely servicing the employer office. The weighting of the size of the broker office does not override the geographic distance, thus preventing a very large office from being identified as the most likely office to service an employer if the very large office is a long distance away from the employer.

In additional to determining likely correlation between the broker office and the employer, data from the web crawler or web scraper is able to be used to determine the identity of broker contacts likely associated with a particular office and thereby determine a number of employees or a number of contacts associated with that particular broker office. This is especially useful in instances where the employer, but not necessary the particular office, of a broker contact is publicly known. Using the information regarding number of broker contacts at a particular office from the web scraper, an artificial intelligence module is able to determine a likelihood that a broker contact for a particular employee is located at that office. If the employer is quite larger and the broker office is relatively small, for example, the system will likely determine that the employer has a broker contact from the next closest, relatively larger office, rather than the smaller office that is geographically closer.

However, in one embodiment, the platform is able to go beyond associating just the broker office likely to serve an employer, and is able to generate a likely individual broker contact (or list of broker contacts with associated probabilities) connected to a client or list of clients. In one embodiment, CRM integration provides for additional detail beyond the office that services a particular account. As users of the site are connected with and tied with their own broker contact, the system is thereby able, by a crowdsourced set of data, a tied network of broker contacts and clients that allows for identification of directly who services which clients.

The broker grouping manual overrides database 342 is operable to provide input to grouping broker identities that are the same but have minor differences in identifying information 336 and override any automatically generated data from the NLP algorithms. Additionally, the broker naming manual overrides database 344 is operable to provide input to generating the best name to tag the group with 338 and override any automatically generated data from the NLP algorithms. The output from the NLP algorithms includes generation of a “Broker Master” mapping table that ties the generalized broker identity back to the original filing 346; this information is included in the broker master database 348.

The present invention also provides for programmatically generating a carrier master with manual overrides 350. A third set of NLP algorithms 352 are used to clean carrier identifying information from all filings 354, group carrier identities that are the same but have minor differences in identifying information (including name and location) 356, generate the best name to tag the group with 358, and generate the best capitalization 360.

The carrier grouping manual overrides database 362 is operable to provide input to grouping broker identities that are the same but have minor differences in identifying information 356 and override any automatically generated data from the NLP algorithms. Additionally, the broker naming manual overrides database 364 is operable to provide input to generating the best name to tag the group with 358 and override any automatically generated data from the NLP algorithms. The output from the NLP algorithms includes generation of a “Carrier Master” mapping table that ties the generalized broker identity back to the original filing 366; this information is included in the carrier master database 368.

To programmatically generate clean data that is ready to be consumed 369, output from the prior steps are analyzed and processed. Data from the Form 5500 Base Database is operable to be analyzed to generate the most recent plan information 370 and populate a most recent plan information database 372. Data from the Form 5500 Schedule C Database and the service provider master database 322 is operable to be analyzed to generate the fees paid to service providers 374 and populate the fees paid to service providers database 376. Data from the Form 5500 Schedule C Database the broker master database 348 is operable to be analyzed to generate fees paid to brokers 378 and populate the fees paid to brokers database 380. Data from the Form 5500 Schedule A Database and the broker master database 348 is operable to be analyzed to generate insurance policies 382 and populate the insurance policies database 384. Data from the carrier master database 368 and the Form 5500 Schedule A Database is operable to be analyzed to generate fees paid to carriers 386 and populate the fees paid to carriers database 388.

Accordingly, the prospecting platform de-duplicates service provider identifying information, and then groups service provider identities together. The prospecting platform is further configured to identify and correct service provider identities that are similar but include minor errors. Alternatively, the system is configured to receive manual input to correct service provider identities. The prospecting platform also determines the best capitalization for the service provider identities. Next, the prospecting platform classifies the service provider type (e.g. benefits vendor, insurance carrier, third-party administrator, attorney, network consultant, accountant, and other similar service providers). The prospecting platform creates a mapping table for service providers, brokers, and carriers that matches a service provider's, a broker's, or a carrier's identity with the corresponding Form 5500 data. The matching data is then stored in a service provider master database and a broker master database. The prospecting platform is configured to generate recent plan information, generate fees paid to service providers, generate commissions and fees paid to brokers, generate insurance policies, and generate premiums paid to carriers. Additionally, the prospecting platform is configured to generate a recent plan database, a fee paid to service providers database, a fee paid to brokers database, a general insurance policies database, and a fees paid to carriers database. As shown in FIG. 3C, the prospecting platform is configured to continuously receive Form 990 data. The Form 990 data is stored in a Form 990 database after the new filings have been received. The Form 990 data is cleaned and filtered using natural language processing algorithms. The prospecting platform is configured to de-duplicate plan contact identifying information captured from the Form 990 data. The prospecting platform is configured to group plan contact identities using the natural language processing algorithms and to identify minor differences in the plan contact identities. The prospecting platform is then configured to generate a best name for the plan contact identity. The prospecting platform is further configured to receive manual overrides for the plan contact information. The prospecting platform is configured to match the plan contact information with a corresponding name and title to create a master plan contact information database. The prospecting platform is then configured to generate an updated LINKEDIN Service Provider Company data warehouse by storing company information from HTML webpages that have similar identities to the names in the Service Provider Database and/or Broker Database. The prospecting platform is configured to use natural language processing algorithms to match Form 5500 data with the LINKEDIN companies and create a LINKEDIN Company Master database. The prospecting platform is configured to receive manual inputs for matching the company information and the Form 5500 data. The prospecting platform is then configured to continuously update the LINKEDIN Service Provider Contact Data to create a LINKEDIN Service Provide Contact Database. The system is further configured to generate a LINKEDIN service provider contact master database using natural language processing and receive manual overrides to correct the data stored in the LINKEDIN service provider contact master database. The prospecting platform is configured to match Form 5500 data to LINKEDIN Service Provider and Broker contact information. As shown in FIG. 3F, the system is further configured to generate a LINKEDIN Plan Contact Database and further match the Form 990 Data with the LINKEDIN Plan Contact data to generate a LINKEDIN Plan Contact Master Database.

In one embodiment, the artificial language engine includes natural language processing (NLP) algorithms to organize the data collected by the web crawler. In another embodiment, the NLP is configured for end-of-sentence (EOS) detection, tokenization, part-of-speech tagging, chunking, and extraction. The artificial intelligence engine is operable to break the text of the various forms and text obtained from social media websites into identifiable sentences and/or words. The artificial intelligence engine is further operable to assign each sentence and/or letter a token. The artificial intelligence engine is configured to analyze each tagged token within a sentence or line of a form to generate compound token corresponding to logic. The artificial intelligence engine is further operable to analyze each compound token and tag the compound token with a label including people, organization, location and/or other similar descriptors. In yet another embodiment, the artificial intelligence engine is further configured to generate a score for each report based on the user input. For example, and not limitation, the software platform is configured to receive user input indicating a desired benefit plan. The artificial intelligence engine is configured to analyze the data to determine potential geographic locations that have market participants interested in the desired plan. The artificial intelligence engine is further configured to provide a score by geographic location on the likelihood of gaining a prospective client.

As benefits providers typically reach employers through benefits brokers or directly through an HR department of an employer, the present invention provides a GUI which aids in contacting benefits brokers or employers directly. The software application is operable to display the aggregated data and/or analyzed data relating to Form 5500 documents, Form 990 documents, and LINKEDIN data on the GUI. The software application is further operable to receive user input via the GUI and to search the aggregated data and/or analyzed data based on the user input. In one embodiment, the software application is operable to filter the analyzed data by funding type, entity type, total number of participants, by type of plan, and by broker. For example, and not limitation, the funding type includes self-funded or fully insured, the entity type includes single employer or multi-employer, and the type of plan includes health and welfare or pension. In another embodiment, the type of plan includes collectively bargained, multiple employer, business travel, statutory disability, and retirement. The software platform is further configured to search healthcare plans based on whether the plans include ambulatory patient services, emergency services, hospitalization, pregnancy, maternity, newborn care, mental health and substance use disorder services, rehabilitative and habilitative services, laboratory services, preventive and wellness services, and pediatric services.

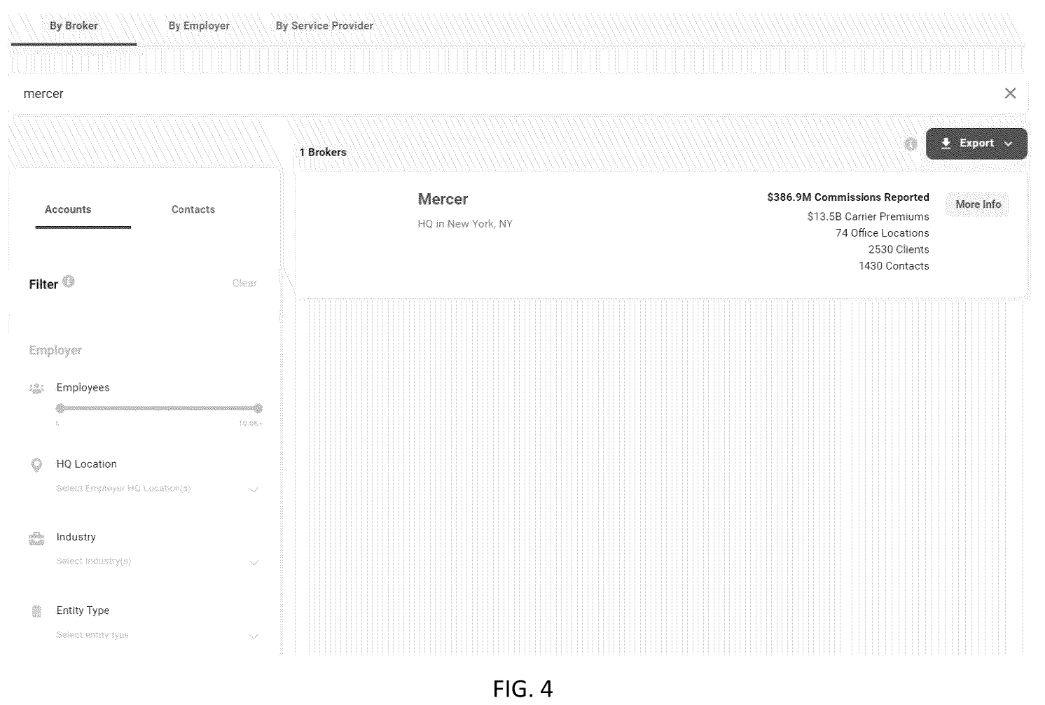

FIG. 4 illustrates a GUI that provides search functionality by employer, by broker, and by service provider. Advantageously, being able to search by each of these parties provides different ways for a benefits provider to prospect for new customers. In other words, the platform provides for a benefits provider to define an ideal customer profile (ICP) and slice the market with advanced filtering using parameters such as employer location, total employees, employer industry, benefits offered, when their benefit policies renew, broker they're using, whether the employer has recently changed its broker, carriers the employer is using, how quickly the company is growing headcount, and others.

In utilizing the platform of the present invention, a benefits provider is operable to identify a total addressable market (TAM), and within the TAM, determine which brokers should be focused on as well as which offices within the target brokers have the greatest exposure to the ideal customer profile for the benefits broker. FIG. 4 illustrates search results for “MERCER” using the “By Broker” search option. The GUI provides for filtering search results by employer information, including headquarter location, industry, and number of employees. Search results are also operable to be filtered by plan funding (e.g., fully-insured or self-funded) and the renewal date for the plan, as well as by broker information, including headquarter location and whether the broker is the primary broker.

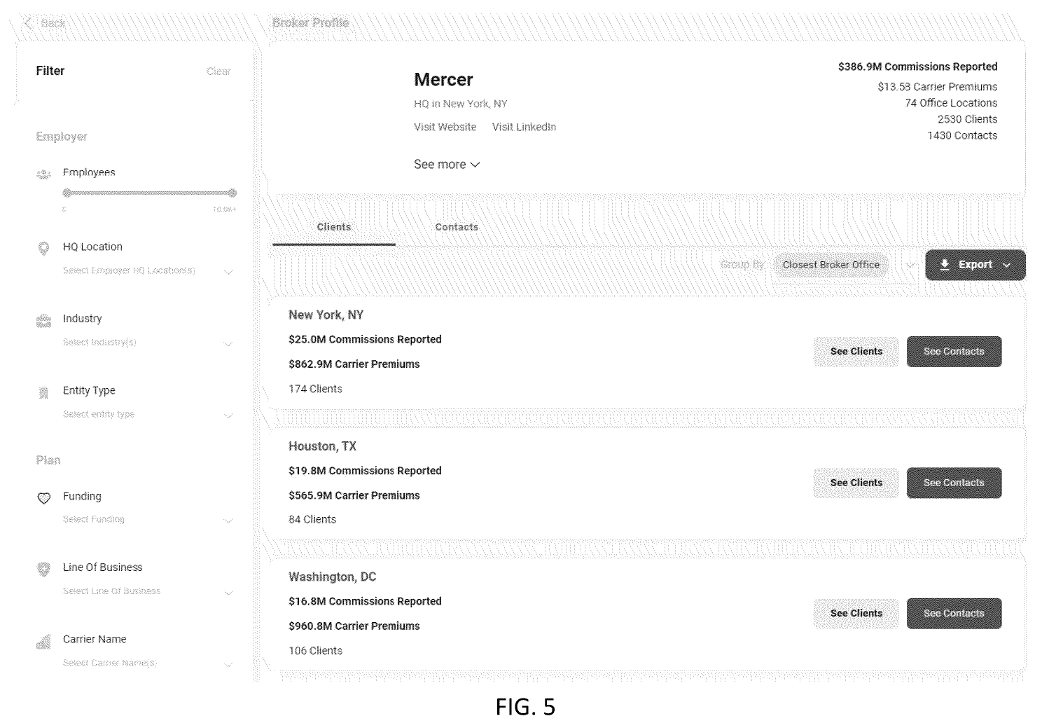

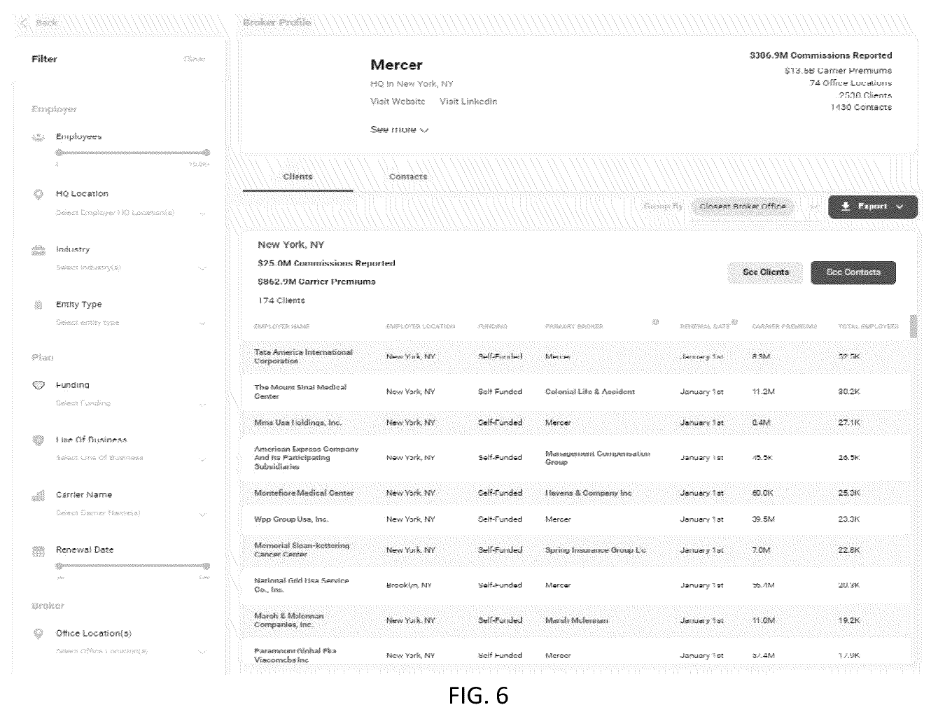

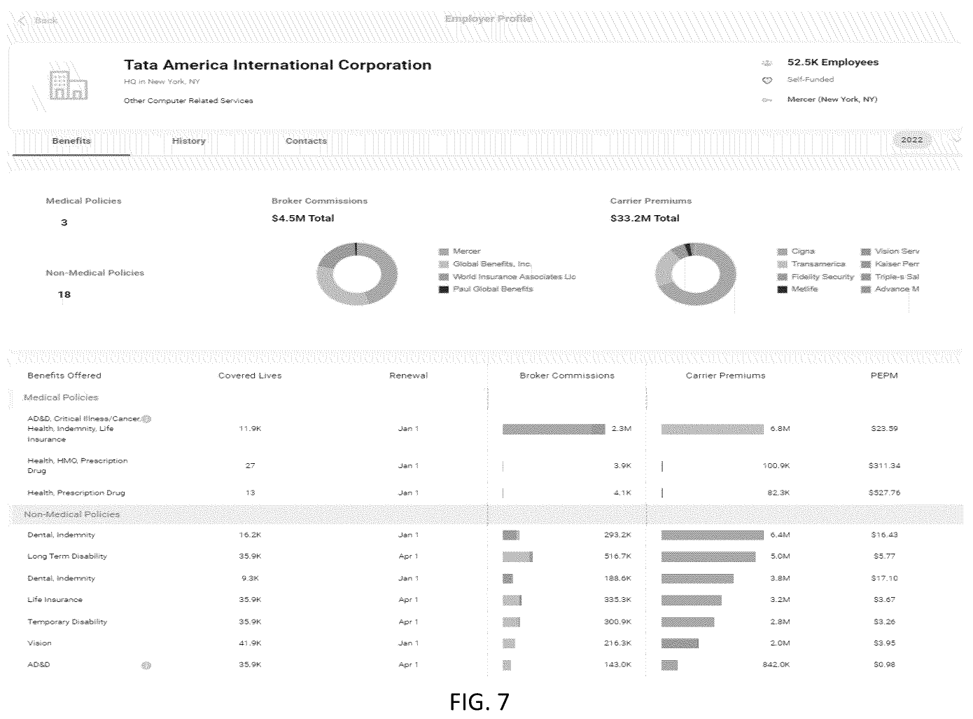

Upon selecting a target broker's profile, each office location is displayed along with the number of clients for that office location and the commissions reported for the prior tax year. FIG. 5 illustrates a list of office locations for Mercer, along with the number of clients for each office location and the commissions reported for the prior tax year for each office location. Clients and contacts for different office locations are operable to be selected. FIG. 6 illustrates a list of clients for a benefits broker sorted by total employees. FIG. 7 illustrates an employer profile which is displayed upon selecting an employer from the client list of the benefits broker. The employer profile provides key information about the employer for a selected tax year, including broker commissions and carrier premiums broken down by company.

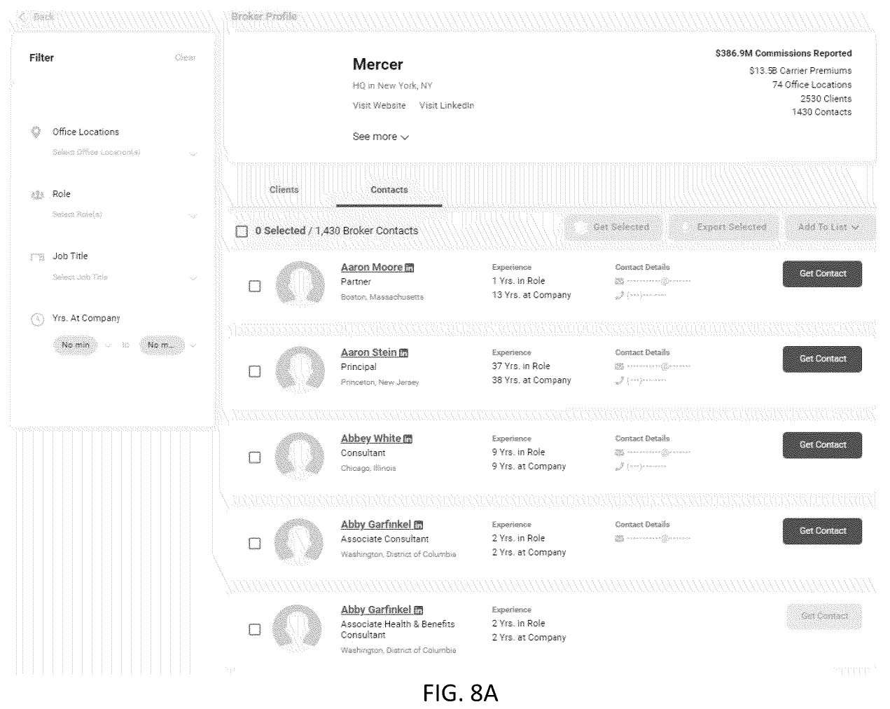

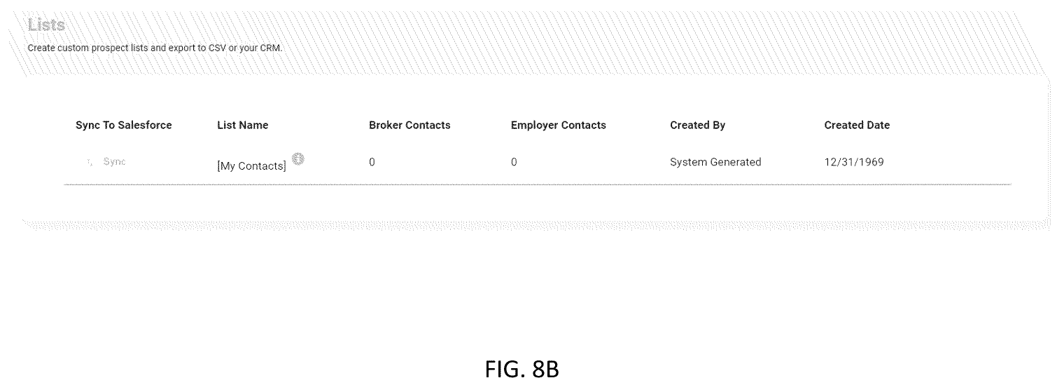

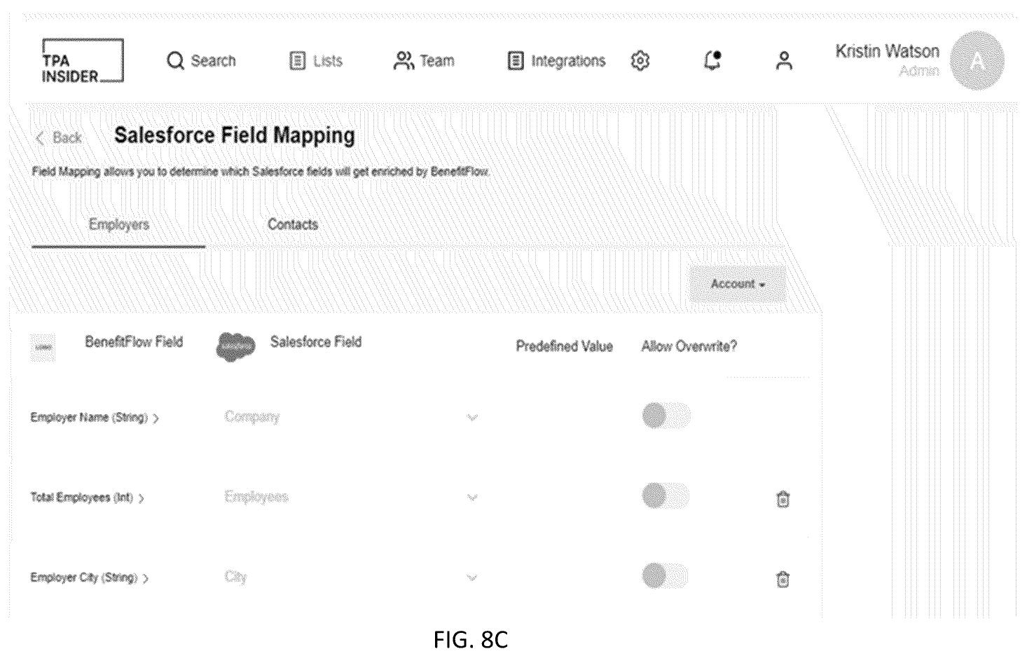

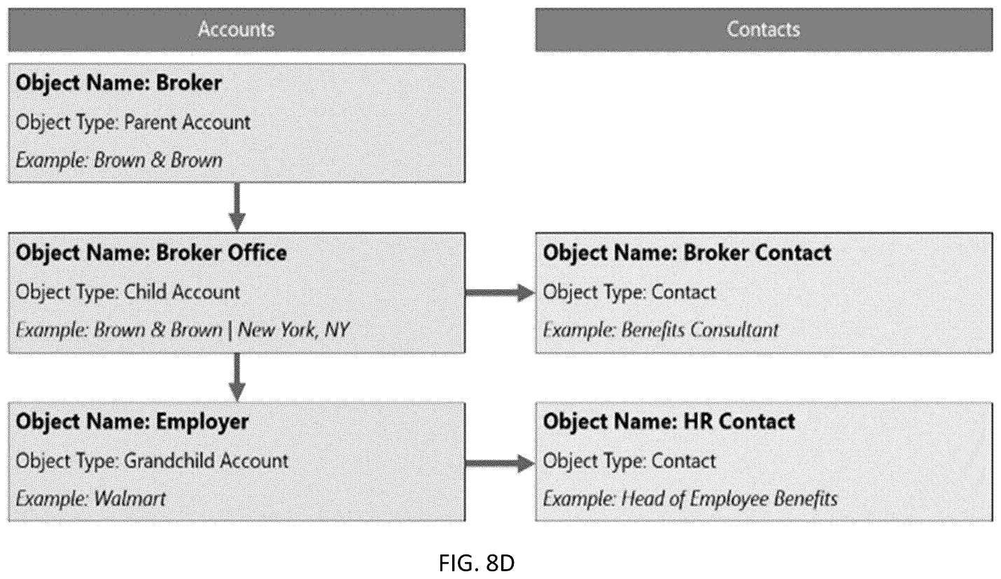

In another embodiment, the software platform is configured to combine the name and contact information of gatekeepers and display the information via the GUI. The software platform is configured to identify relevant individuals within a selected brokerage firm (e.g. gatekeepers) based on the prospective client and brokerage office location. This enables the present invention to provide an end-to-end process for (1) looking up a brokerage's book of business, (2) identifying potential opportunities, (3) accessing the names of individuals within the brokerage who own the client relationships (e.g. gatekeepers) and (4) providing contact information for those individuals. FIG. 8A illustrates a contacts page for an office location of a benefits broker. In one embodiment, key filtering parameters for searching across contacts also include job role, job title, location, years at the company, whether the contact is a licensed benefits producer, and others. A “Job Role” field is highly customized and acts to group thousands of “Job Title” permutations into smaller, meaningful categories. The contacts page provides a list of key personnel at the benefits broker, and provides contact information including an email address, a phone number, and a link to a social media profile such as a LINKEDIN profile for each contact if available. This information is obtained via a web crawler or a web scraper in combination with artificial intelligence (AI) or machine learning (ML) algorithms. One challenge in discovering relevant contacts within a brokerage firm is that job titles are not often consistent across brokerage firms or even within a firm. Prospectors usually wish to target producers within a brokerage firm, as producers are the parties who sell insurance products. However, the term producer is an informal term within the brokerage industry, and many “producers” have formal job titles such as “vice president” or “benefits consultant.” The present invention provides for consistently identifying producers, regardless of job title, by incorporating data obtained from state-level insurance agency databases, which enables identification of contacts as producers. Producers are required to maintain active licenses with state-level insurance agencies in the states in which they conduct business. States typically offer four license types: “Health”, “Life”, “Property”, and “Casualty”. The platform of the present invention is operable to retrieve data from state-level insurance agency databases through an application programming interface (API) or via a web crawler, web scraper, or any other method or tool known in the art which provides for obtaining data from an online database or online source. The platform is operable to cause a “producer” label to be associated with a contact who is identified as a producer on the contacts page of the present invention. In another embodiment, producers are identified using different color highlighting for the contact information (such as green compared to white highlighting for non-producer contacts) or via use of a symbol such as an asterisk next to the name of the contact. Each producer contact is also operable to include an indication of the license types currently active for the producer, including “Health”, “Life”, “Property”, and/or “Casualty”. In one embodiment, the contacts page is sorted such that contacts identified as producers appear first in the contacts list. The platform is operable to implement a secondary sort of producer contacts such that producer contacts are sorted in descending order by years in a role, years at a company, or by the number of licenses the producers have. Selected contacts and their contact information are operable to be exported to a CSV file and stored locally.

Advantageously, the present invention provides for creation of custom prospect lists and exporting custom prospect lists to third-party applications. An issue commonly faced by prospectors includes obtaining and organizing information relating to both an end customer and a broker through a Customer Relationship Management (CRM) software. By way of example, a prospector representing a health insurance company wishes to sell products to a corporation, such as WALMART. The prospector must have contact information for the human resources department at WALMART, including key contacts within the relevant human resources department at WALMART, as well as the brokerage firm servicing WALMART, the office location of the brokerage firm servicing WALMART, and the specific producer or benefits consultant within the brokerage firm office servicing WALMART.

Currently, CRM software platforms do not provide a solution to create and link objects representing the relevant information for the customer and the brokerage firm. In the example provided above, a CRM software platform must include five different types of objects, including at least three objects for the brokerage firm (an object representing the brokerage firm, an object representing the office location, and at least one object representing each brokerage firm contact) and at least two objects for the employer (an object representing the employer and at least one object representing each human resources contact). For this information to be usable to a prospector, the software must include associations or connections between these objects. This is currently not practical or possible to accomplish using traditional CRM software. The platform of the present invention provides for creation of a custom contact list which includes the at least three objects for the brokerage office and the at least two objects for the customer. The platform of the present invention also provides for export of the at least three objects associated with the brokerage firm and the at least two objects associated with the customer from the platform of the present invention in a pre-packaged format, such as a CSV file, which is operable to be imported into CRM software, such as SALESFORCE. The pre-packaged format maintains the associations between the brokerage objects and the customer objects, thereby providing a solution for linking this information within CRM software.

FIG. 8B illustrates a custom prospect list GUI according to one embodiment of the present invention. The custom prospect list provides for creating custom lists including information for a brokerage firm and a customer, including but not limited to, details about the brokerage firm, the office location of the brokerage firm, at least one contact for the brokerage firm, details about the employer, and at least one contact for the employer, such as a human resources contact for the human employer. Each list is selectable and includes a number of employers, a number of contacts, who created the list, and the date of creation of the list.

FIG. 8C illustrates a CRM integration interface for integrating custom prospect lists with or exporting custom prospect lists to a CRM software platform. The CRM integration interface provides a list of employers and a list of contacts and includes field mapping to allow a user to determine which CRM fields, such as SALESFORCE fields, are populated with data from the platform of the present invention. For the list of employers, a column including a field of the platform of the present invention, including an employer name (a string of text), total employees (an integer), and employer city (a string of text) is included. The corresponding CRM fields, such as SALESFORCE fields, are represented in a second column and indicate the fields which will receive information in the CRM platform. As shown in FIG. 8C, the CRM field of company will receive the employer name, the CRM field of employees will receive the number of employees, and the CRM field of city will receive the employer city. The platform of the present invention also provides for overwriting of information in a CRM platform with information from the platform of the present invention if a binary button is selected to allow for overwriting of information.

FIG. 8D illustrates a schematic of CRM platform object structure, including account objects and contacts objects. The accounts objects include broker, broker office, and employer. The contacts objects include broker contact and HR contact.

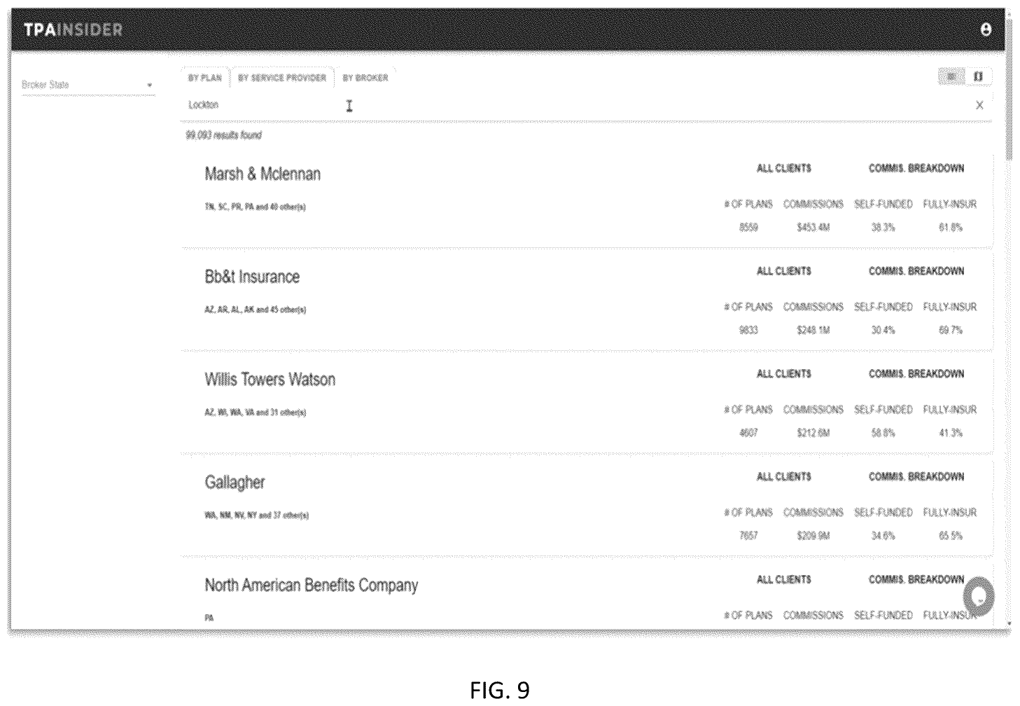

FIG. 9 illustrates an alternative GUI for conducting a broker search. The software platform shown in FIG. 9 is configured to search by service provider, by plan type, and by broker state. The software platform is configured to display the total number of client plans, the commission earned from all clients plans, the commissions earned from self-funded plans, and the commissions earned from fully-insured plans. In another embodiment, the software platform is configured to filter search results based on the specific industries that certain brokerages are predominantly exposed to. In one embodiment, the present invention is configured to provide a map view of networks for an area. The software platform is configured to display a geographic map for a selected area. The GUI is further operable to display color-coded dots and other similar visual indicators to show the regional market share of an insurance network (e.g. United Healthcare, Cigna, Aetna) for the displayed geographic map.

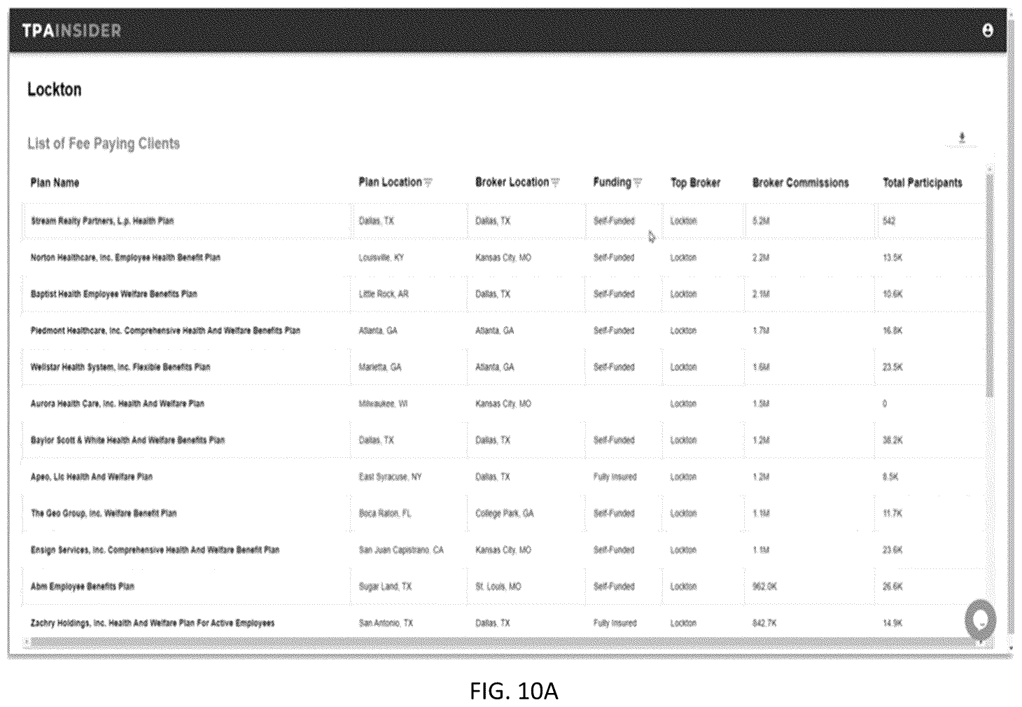

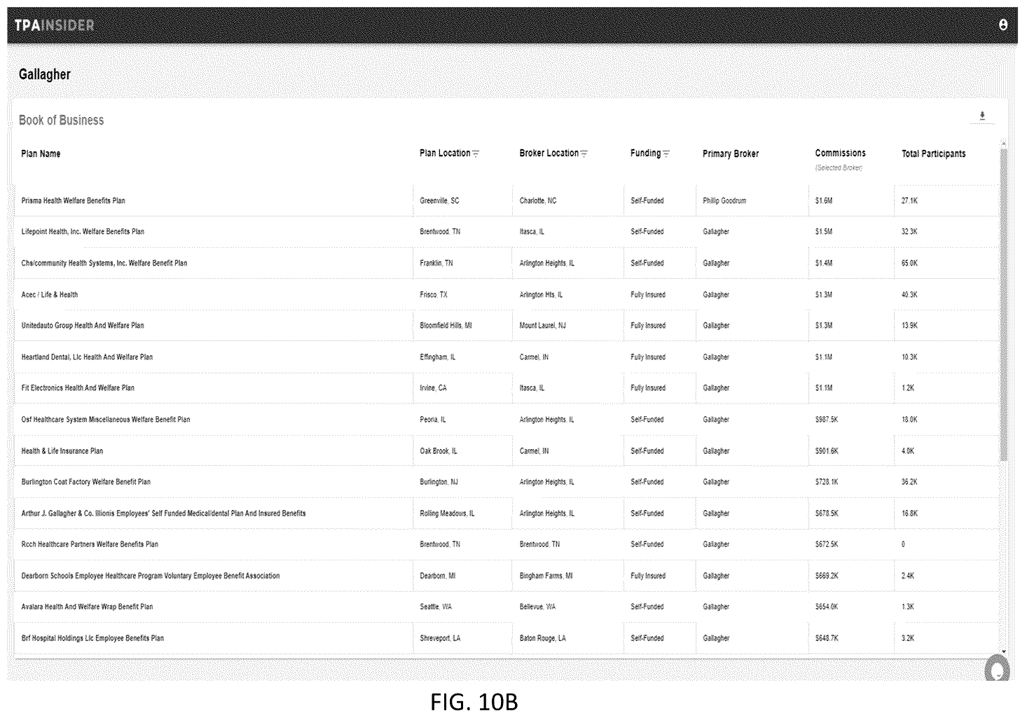

In one embodiment, as shown in FIG. 10A, the software platform is configured to aggregate and display a list of fee-paying clients for a broker. The software platform is further configured to show the plan location, broker location, funding, broker commission, and total participants in a plan. The software platform is configured to sort and/or filter by plan location, broker location, and funding. In another embodiment, the system is further configured to receive user input to select a plan and to display plan information. In one embodiment, the GUI is configured to receive user selection of a client in the broker's client list, and the GUI is configured to display a plan summary for the selected client. In yet another embodiment, the GUI includes a download button operable to create a spreadsheet file (e.g. csv, .xls, .xlsx) including the information displayed via the GUI (e.g. broker's client list).

FIG. 10B illustrates a client list for a broker according to another embodiment of the present invention. By providing broker client lists, third-party administrators or other service providers are able to know which broker to contact if a prospective client is on the broker's client list. The GUI illustrated in FIG. 10B displays when the plans are in effect, the plan location, the broker location, the type of funding for the plan, the primary broker, commissions for the selected broker, and total participants in the plan. In another embodiment, the present invention is configured to identify all brokers for a prospective client. The system is further configured to display the “primary broker” as the broker that has the greatest commission total. Alternatively, in another embodiment, the GUI is configured to display the top brokers for each prospective client and display the commissions for each broker. In one embodiment, the GUI is configured to receive user selection of a client in the broker's client list, and the GUI is configured to display a plan summary for the selected client. In yet another embodiment, the GUI includes a download button operable to create a spreadsheet file (e.g. csv, .xls, .xlsx) including the information displayed via the GUI (e.g. broker's client list).

In one embodiment, the present invention is configured to generate a list of existing clients for a service provider based on the data captured from the third-party data source. The client list includes clients for service providers, benefits vendors, insurance carriers, third-party administrators, brokers, and other plan professionals.

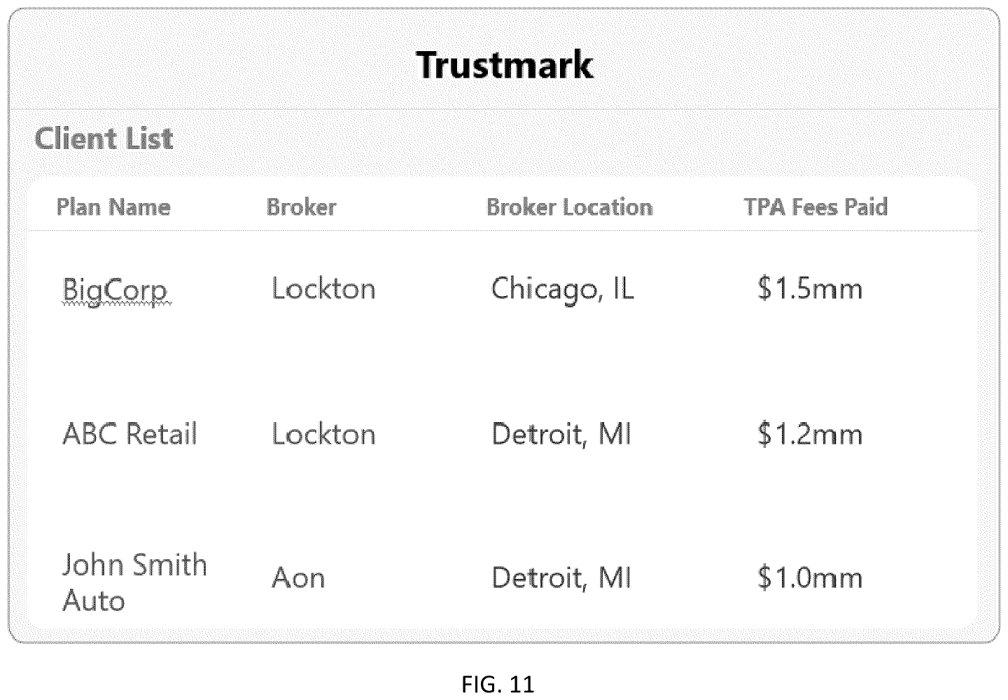

FIG. 11 illustrates a GUI view of a client list for a benefits vendor, insurance carrier, or third-party administrator, including the plan name, the type of funding, the broker location, and the total participants in the plan.

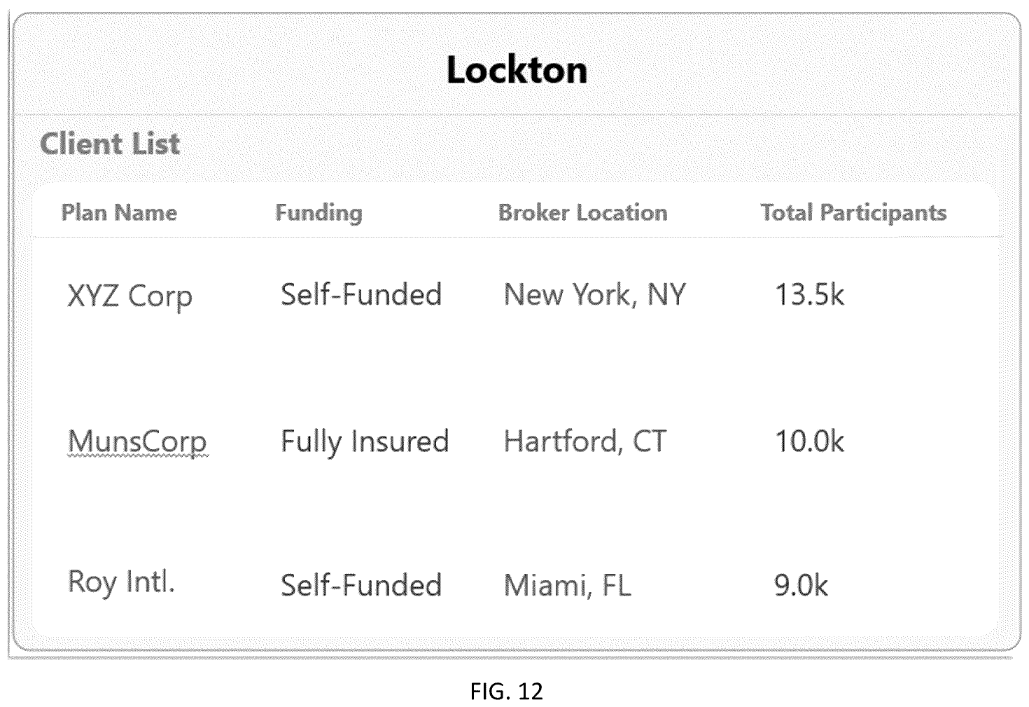

FIG. 12 illustrates a GUI screenshot of a client list for a broker according to one embodiment of the present invention. Advantageously, the present invention enables benefits vendors, insurance carriers, third-party administrators or other service providers to know which broker to contact if a prospective client is on the broker's client list. The GUI illustrated in FIG. 12 displays the plan location, the broker location, the type of funding for the plan, the primary broker, commissions for the selected broker, and total participants in the plan. In another embodiment, the present invention is configured to identify all brokers for a prospective client. The system is further configured to display the “primary broker” as the broker that has the greatest commission total. Alternatively, in another embodiment, the GUI is configured to display the top brokers for each prospective client and display the commissions for each broker. In one embodiment, the GUI is configured to receive user selection of a client in the broker's client list, and the GUI is configured to display a plan summary for the selected client. In yet another embodiment, the GUI includes a download button operable to create a spreadsheet file (e.g. csv, .xls, .xlsx) including the information displayed via the GUI (e.g. broker's client list).

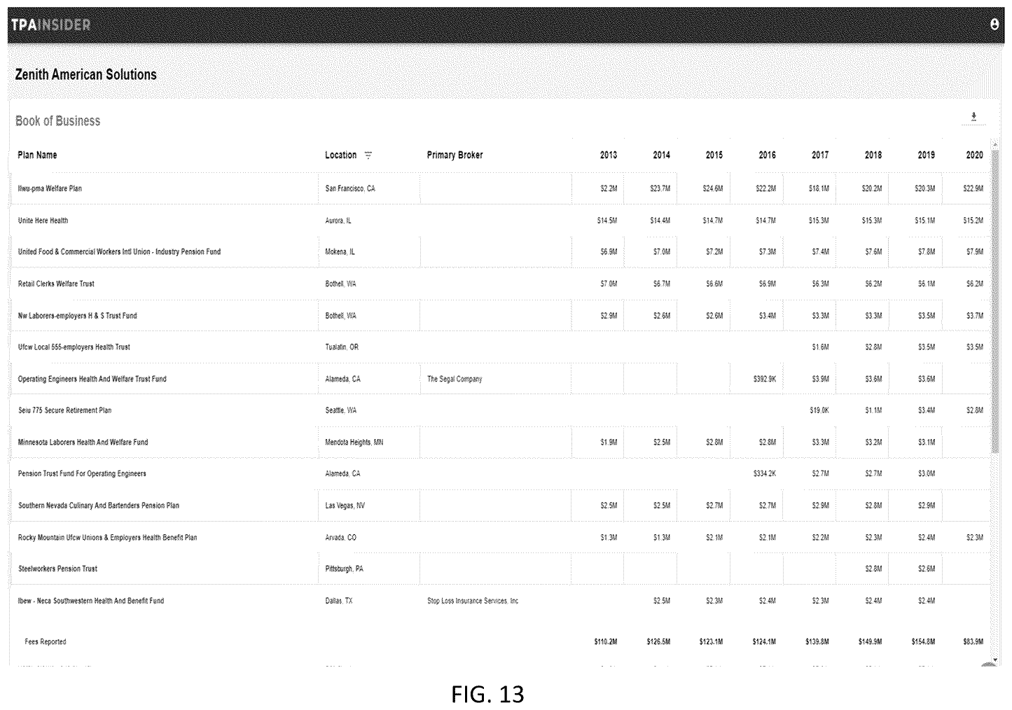

Advantageously, the present invention is also operable to display all plans for a benefits vendor, insurance carrier, or third-party administrator. By being able to search for the book of business of both brokers and benefits vendors, insurance carriers, or third-party administrators, the platform of the present invention provides for unprecedented opportunities to identify potential clients and leads. An alternative GUI operable to display all plans for a benefits vendor, insurance carrier, or third-party administrator is shown in FIG. 13. The system is configured to display a client list for a benefits vendor, insurance carrier, or third-party administrator after receiving a selection of a third-party administrator. The GUI is configured to display each plan in the benefits vendor, insurance carrier, or third-party administrator's client list, the location of the plan, the primary broker for the plan, and the amount of fees charged by the benefits vendor, insurance carrier, or third-party administrator to each plan by year. The GUI is further configured to display the sum of all fees by year. The locations of the plans of the client list are filterable in real-time by state. The GUI displays when the plans are in effect, the primary broker associated with the plan, and the commission for a plan by year. Advantageously, this enables competing benefits vendors, insurance carriers, and third-party administrators to target clients of their competitors. In one embodiment, the GUI is configured to receive user selection of a client in the benefits vendor, insurance carrier, or third-party administrator's client list, and the GUI is configured to display a plan summary for the selected client. In yet another embodiment, the GUI includes a download button operable to create a spreadsheet file (e.g. csv,. xls,.xlsx) including the information displayed via the GUI (e.g. third-party administrator's client list). Additionally, the GUI is configured to display a client list for a selected broker and or a selected service provider, including plan name, plan location, broker location, primary broker, and fees by year.

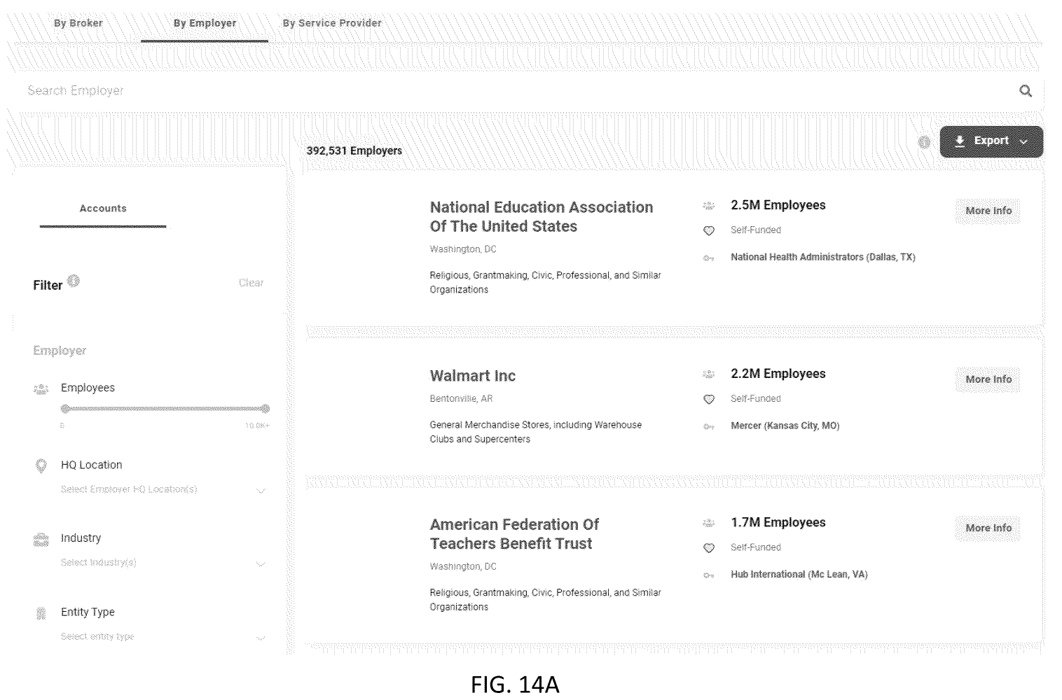

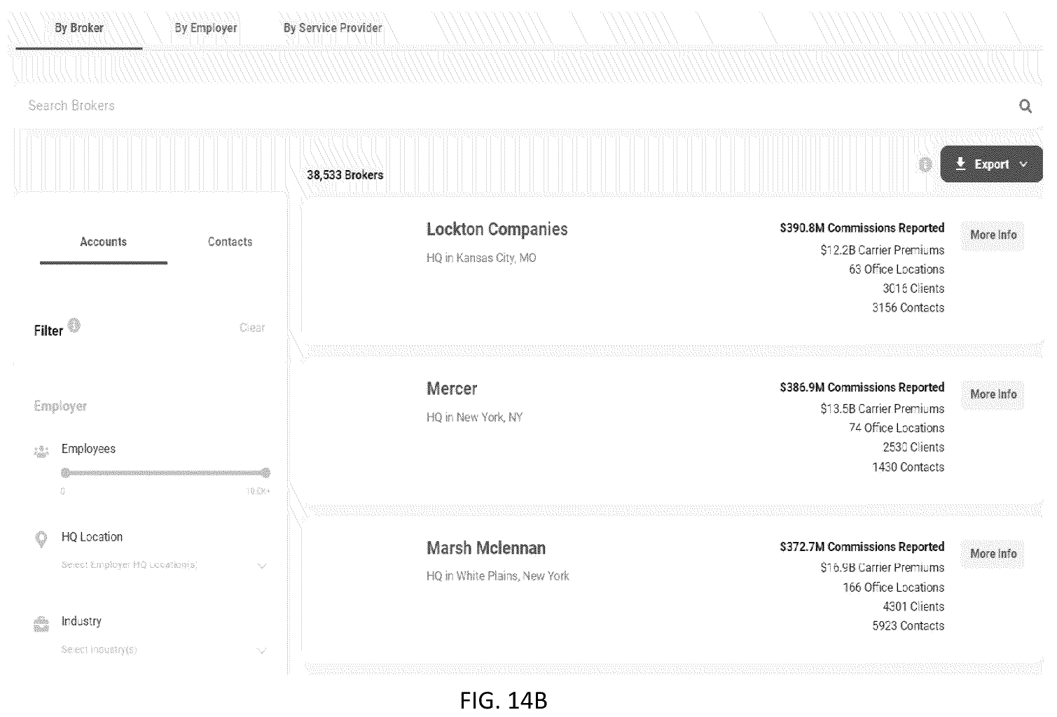

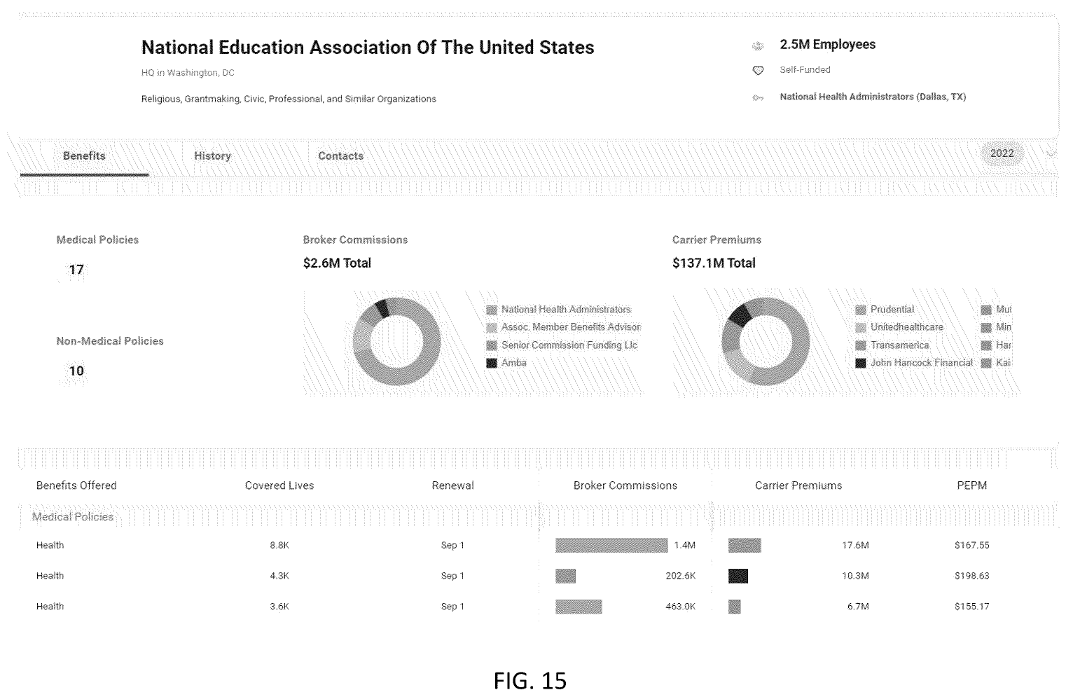

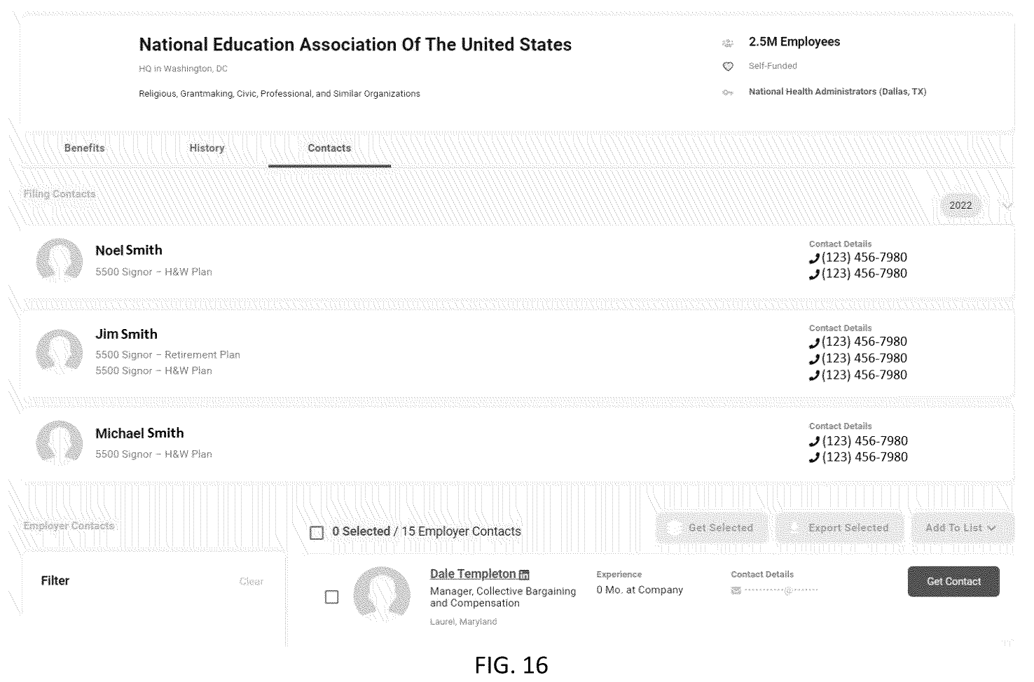

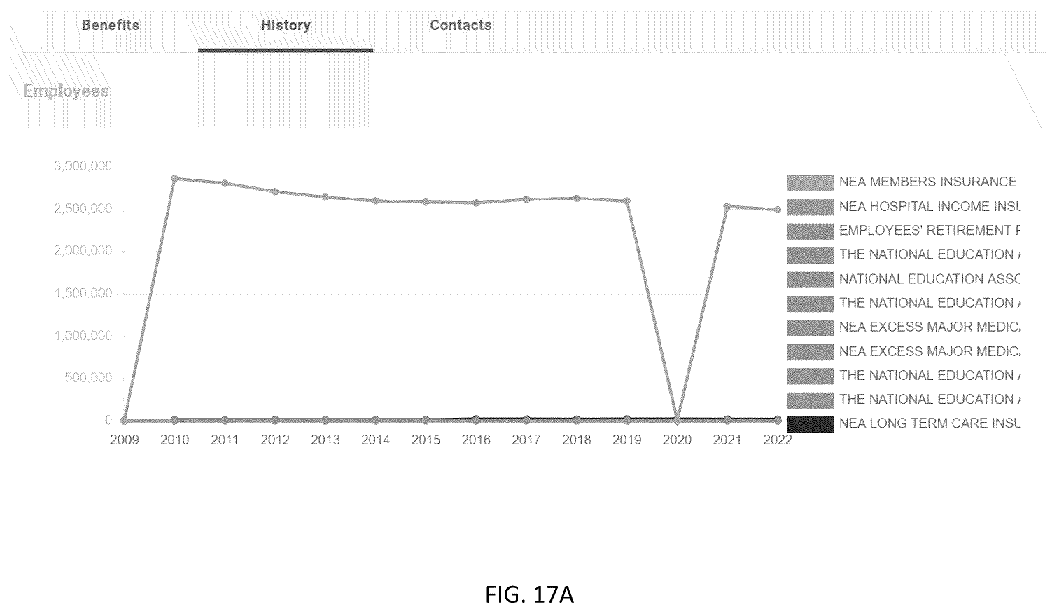

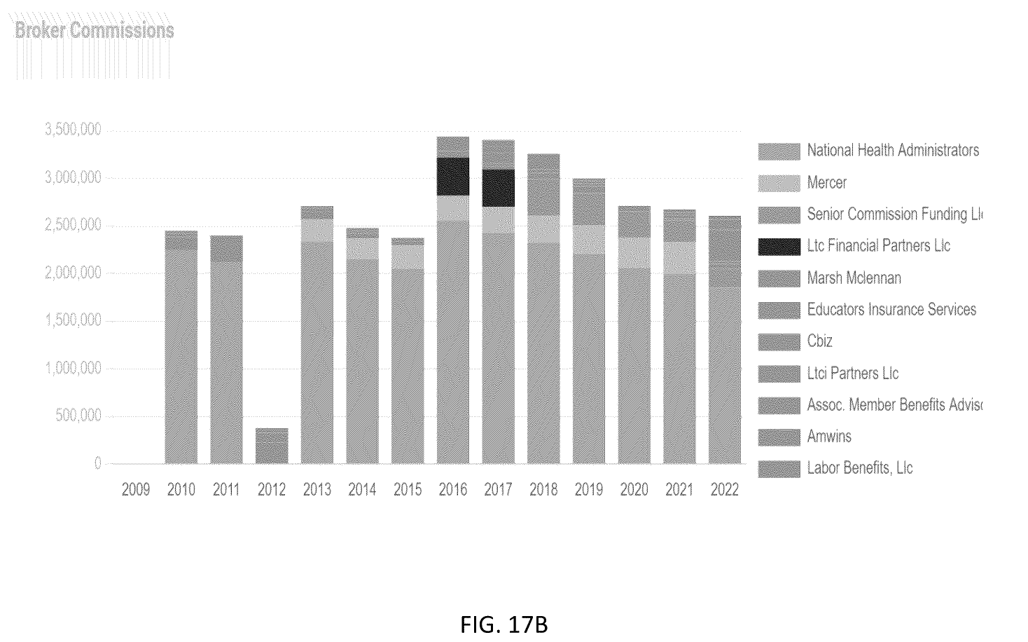

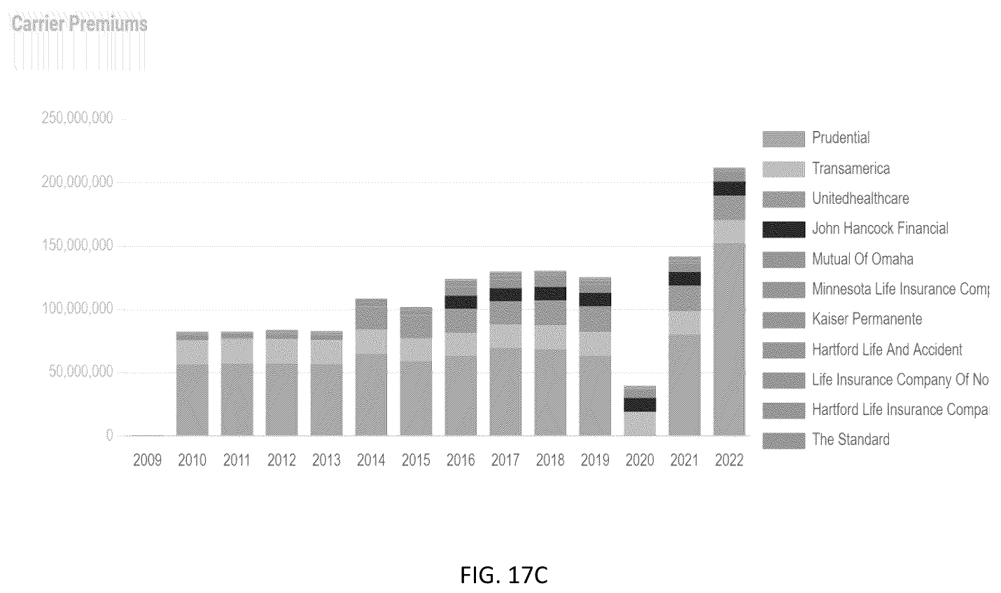

In utilizing the platform of the present invention, a benefits provider is also operable to identify a total addressable market (TAM), and within the TAM, determine which employers should be focused on and the key contacts for each employer. FIG. 14A illustrates search results for “AMAZON” using the employer search functionality, while FIG. 14B illustrates similar search results using a broker search functionality. The GUI provides for filtering search results by employer information, including headquarter location, industry, and number of employees. Search results are also operable to be filtered by plan funding (e.g., fully-insured or self-funded) and the renewal date for the plan. FIG. 15 illustrates the employer profile for “Natural Education Association of the United States”. The employer profile includes the number of employees, funding status, benefits, history, contacts, broker commissions, and carrier premiums. FIG. 16 illustrates the contacts for “Natural Education Association of the United States”. Upon activation of the “Get Contact” button, the contact information for each contact is revealed. In one embodiment, contact information includes an email, phone number, and social media profile link such as a LINKEDIN profile link. In one embodiment, contacts are sorted by “producer” status as described with respect to FIG. 8A above. Specifically, in one embodiment, the contacts are sorted such that contacts identified as producers appear first in the contacts list. The platform is operable to implement a secondary sort of producer contacts such that producer contacts are sorted in descending order by years in a role, years at a company, or by the number of licenses the producers have. Selected contacts and their contact information are operable to be exported to a CSV file and stored locally. FIG. 17A illustrates one embodiment of the history tab for “Natural Education Association of the United States”, showing a line graph of active participants in plans. FIG. 17B illustrates another embodiment of the history tab for “Natural Education Association of the United States”, showing a bar chart of broker commissions over time. FIG. 17C illustrates yet another embodiment of the history tab for “Natural Education Association of the United States”, showing a bar chart of carrier premiums over time.

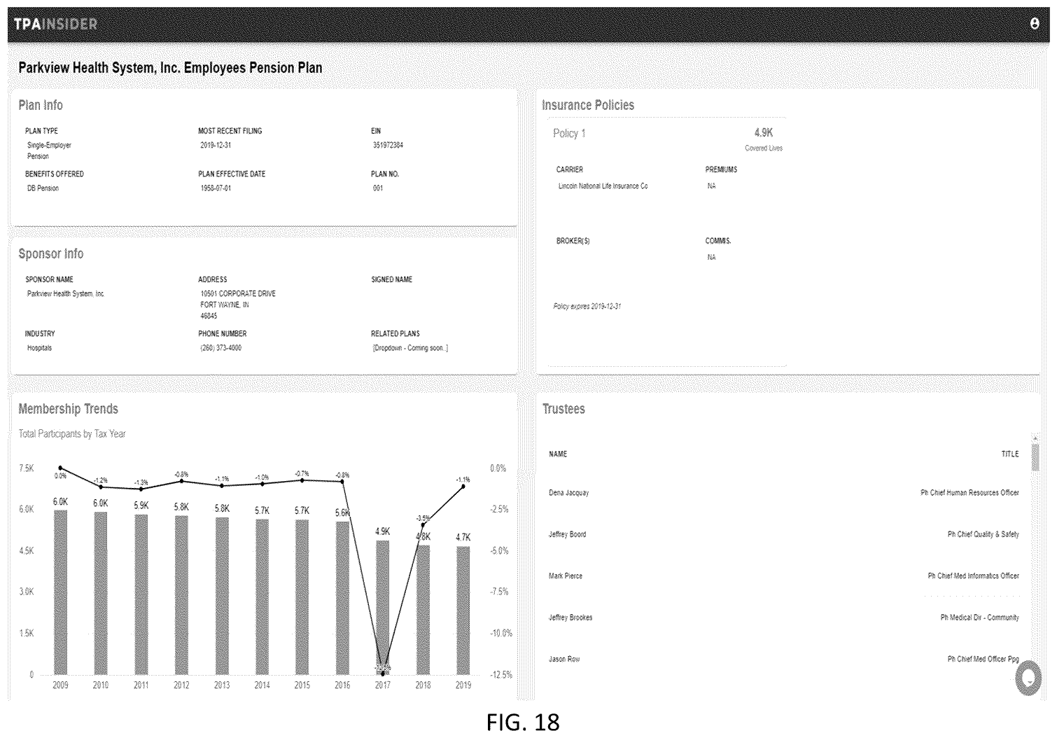

FIG. 18 illustrates an alternative GUI displaying information about a pension plan for a company. In one embodiment, the GUI displays a pension plan summary including plan information, sponsor information, policy information, and membership trends. Advantageously, the system is further operable to display related plans. The system is configured to display every plan associated with a company without requiring a further search. Advantageously, this enables a user to see all plans for a company from the plan summary on the GUI. The system is further configured to display the trustees for the plan. The system is further operable to generate a plan summary for each service provider, benefits vendor, insurance carrier, third-party administrator, broker, and other plan professionals. The system is operable to display all plans for a broker and the fees being paid for each plan. Advantageously, the system is further operable to display contact information for each broker and/or service provider to provide end-to-end prospecting. In another embodiment, the software platform is configured to receive user input for the list of potential clients. For example, and not limitation, the system is configured to favorite or create at least one list including selecting plans, service providers and/or brokers based on user input.

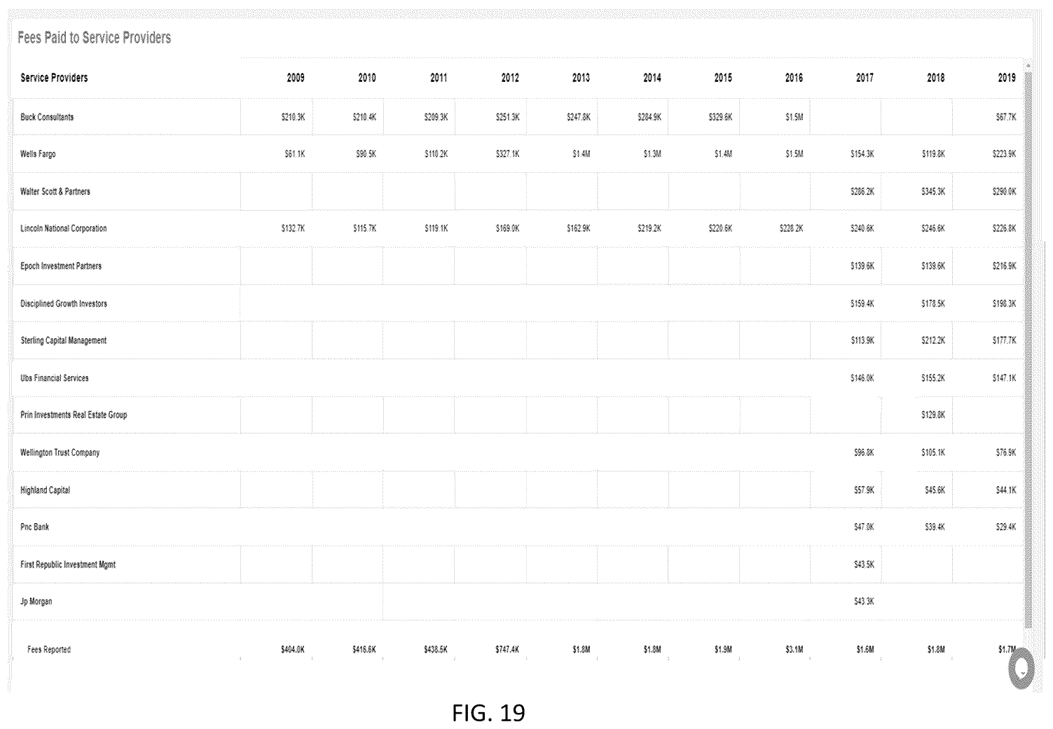

In one embodiment, as shown in FIG. 19, the software platform is configured to display fees paid to service providers by year, by service provider, and the total amount of fees paid. The fees indicate the amount paid to each service provider by their clients. In one embodiment, the system is configured to receive a user selection of one of the listed service providers and display all of the plans and/or clients under the selected service provider.

In another embodiment, the software platform is configured to receive user input for a type of employee benefit plan (e.g. health and welfare) and display companies and their contact information based on the type of employee benefit plan. In yet another embodiment, the software platform is configured to filter data based on company name, state, benefits broker, and/or professional employer organization. The present invention is operable to display results by company and show a company's state, number of employees, filing status, benefits renewal date, broker affiliation, benefits broker, broker share percentage, revenue, largest carrier, and the premium. The software platform is further configured to receive user selection for a company via click and drag functionality, scrolling functionality, and other similar methods of receiving user input via the GUI. The system is configured to display company's profile including location, website, Employer Identification Number (EIN) number, company description, benefits broker, trustee, and/or third-party administrator. In yet another embodiment, the present invention is configured to display commissions, fees, and premiums for each company, broker, and service provider. In another embodiment, the present invention is configured to sort by carrier participants, premium, fees, commission, and/or revenue.

In yet another embodiment, the GUI is configured to generate a visual representation of the aggregated and/or analyzed data. In one embodiment, the GUI is configured to generate a geographic map with color coded activity by broker and/or service providers. For example, and not limitation, the map includes a representation of the United States, and each service provider and/or broker is assigned a color and their area of activity is displayed on the map with the broker's color. The GUI is operable to receive user selection for a part of the map and to zoom in (or zoom out) on a location. The software platform is configured to update the modified map to provide real-time statistics on the location displayed on the GUI. Additionally, the GUI is configured to visualize the physical relationship of the office locations of brokerage firms, benefits vendors, insurance carriers, third-party administrators, and service providers (represented by color coded symbols), and the clients they serve (distinguished by different color coded symbols). The GUI is operable to receive user selection on any of those symbols to generate additional information (including client lists, names of key contacts, contact information and other descriptive info).

In yet another embodiment, the present invention is configured to create a lead list. The lead list is filterable by location, market participants, brokers, and similar filters. In another embodiment, the software platform is configured to receive a list of favorited opportunities for a user. The software platform is configured to configured to provide a recommendation for other and/or new plans to target based on the favorited opportunities, size, type and geographic locations. In one embodiment, the artificial intelligence engine is configured to identify at least one geographic location for potential clients based on a selected healthcare and/or pension plan and the analyzed data. In another embodiment, the software platform is configured to filter by office location for each broker. The system is further configured to capture data from LINKEDIN (e.g. job title and office location) and determine individuals who are likely responsible for maintaining a relationship with a customer. Advantageously, the software platform is further configured to determine the contact information (e.g. phone number, email, and/or LINKEDIN contact such as a LINKEDIN account) for agents, brokers, gatekeepers, and other key points of contacts and to display the contact information via the GUI. This removes the need for benefits vendors, insurance carriers, third-party administrators and other service providers from searching hundreds of employees on LINKEDIN and/or a company's website to determine the best point of contact.

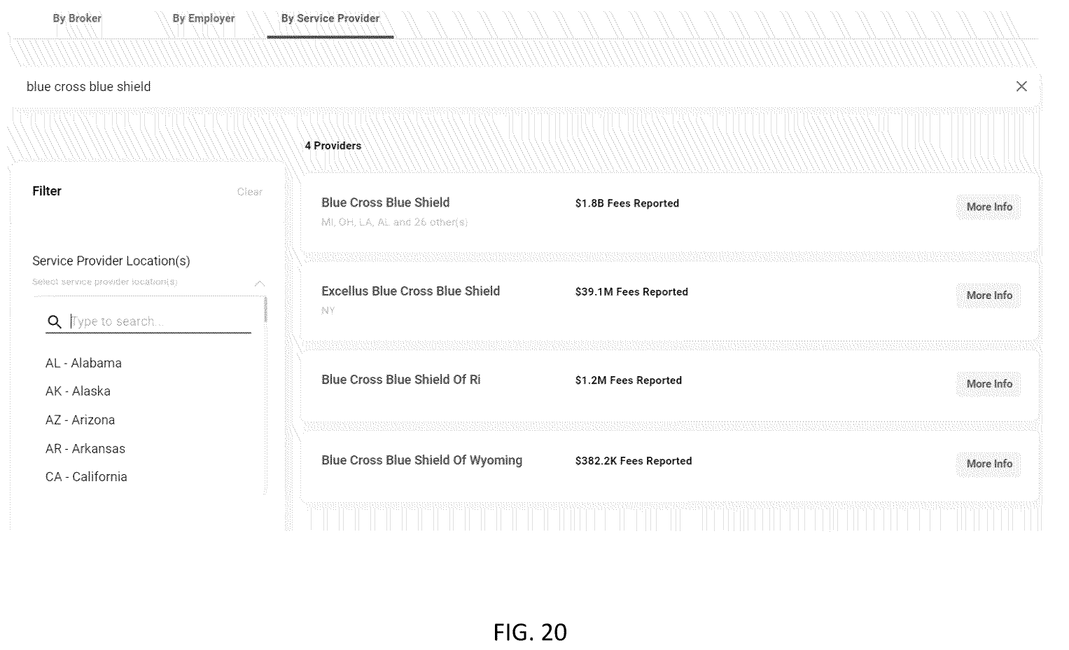

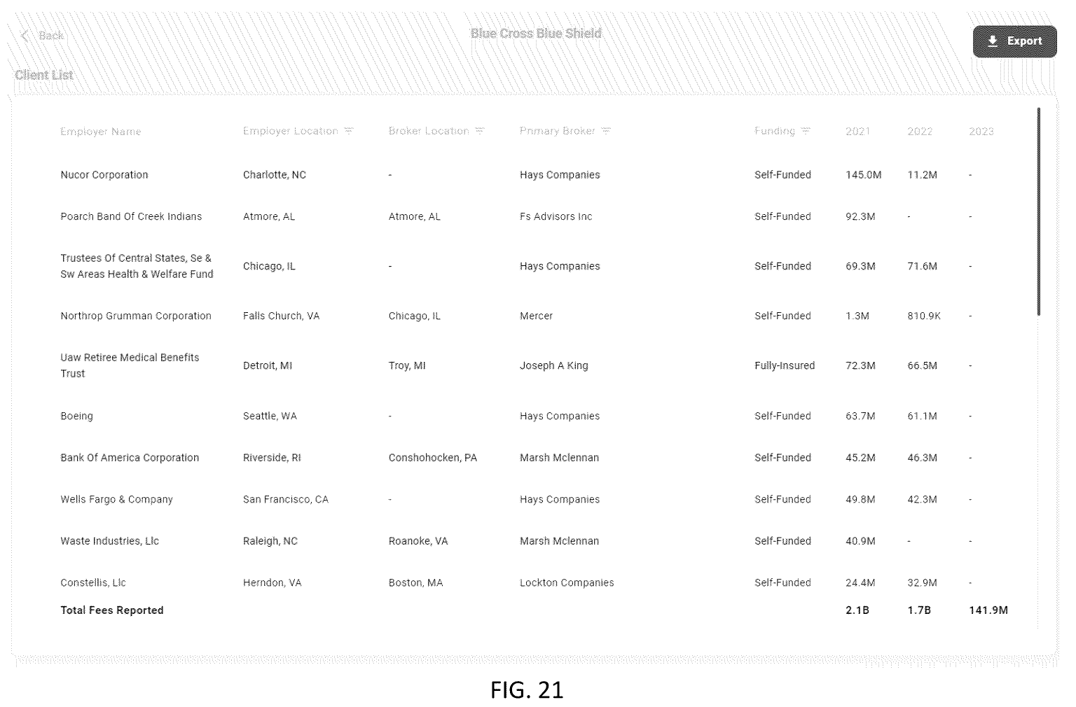

FIG. 20 illustrates search results for “BLUE CROSS BLUE SHIELD” using the “By Service Provider” search option. The GUI provides for filtering search results by service provider location(s), and includes a drop-down menu which provides for filtering by state of the service providers. FIG. 21 illustrates a client list for a service provider sorted by fees for the most recent tax year. The client list includes the plan location, broker location, primary broker, plan type, and fees for recent tax years for each client, as well as the total fees reported for recent tax years.

The end-to-end prospecting platform for benefits vendors, insurance carriers, third-party administrators and other plan professionals is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), Decision Trees, Random Forests, and/or natural language processing (NLP). The end-to-end prospecting platform for benefits vendors, insurance carriers, third-party administrators and other plan professionals is operable to use any of the aforementioned learning techniques alone or in combination.

Further, the end-to-end prospecting platform for benefits vendors, insurance carriers, third-party administrators and other plan professionals is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The end-to-end prospecting platform for benefits vendors, insurance carriers, third-party administrators and other plan professionals is preferably operable to recommend and/or perform actions based on historical data, external data sources, ML, AI, NNs, and/or other learning techniques. The end-to-end prospecting platform for benefits vendors, insurance carriers, third-party administrators and other plan professionals is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

In yet another embodiment, the present invention is configured for automated email marketing. The artificial intelligence engine is configured to determine potential clients based on their LINKEDIN profile, Form 5500 documents, Form 990 documents, and similar data sources. The artificial intelligence engine is further configured to suggest an email based on the client's information. For example, and not limitation, the software platform is operable to determine that a potential client is a new attorney based on their education experience on LINKEDIN. Additionally, the software platform is configured to gather a company's description from LINKEDIN. The software platform is configured suggest an email related to an individual's experience (e.g. patent law) to establish a personal connection with the potential client.

In one embodiment, the present invention is configured for crowdsourcing to correct errors in the captured data. By providing for correction of data by user accounts, the present invention provides for improved data quality and increased user engagement. For example, and not limitation, the software platform includes a virtual credit that is used to access contact information for clients. In one embodiment, virtual credits are earned by correcting errors in the captured data. For example, and not limitation, the lead generation platform is configured to output a document with all data captured from the third-party data source. The lead generation platform is configured to receive user input for each datum and to update the data in the document and the data stored on the at least one remote server. The platform is further configured to distribute a virtual credit to a user's account based on the number of corrections made by the user. In one embodiment, the virtual credit is a “Contact Credit”, a currency exchanged for contact data in a usage-based model of the present invention.

The present invention is necessarily rooted in computer technology in order to overcome a problem specifically arising in the realm of computer networks. More specifically, the present invention electronically searches and parses, in real-time, hundreds to thousands of documents to provide lead generation for healthcare and benefit plan analysis. This immense amount of content, which cannot be parsed in real-time or near-real-time by humans, was not available prior to the advent of the Internet. Prior to the Internet, there were not distributed data sources with different data formats including Form 5500 data, Form 990 data, or social media data. The aggregation of this data and presentation of this data in a standardized format, e.g. through the GUI of the present invention, solves an Internet-specific problem and is not something that is practically performed by the mind.

Additionally, many of these documents are offered electronically and only through the Internet, but in unstructured or in a variety of structured data formats that are not uniformly analyzed with traditional research and analysis methods. Thus, it is not possible to automatically analyze and present data from documents except by using specific computer and electronic networking technology, including GUIs. The GUIs described in the present invention are also a product of computer technology and Internet connectivity, and as such were unavailable before computing technology and the Internet.

Furthermore, the high-throughput, real-time screening necessitated by the enormous number of documents along with the constraints of computer displays requires technological features that did not exist before the Internet. Specifically, the need to review multiple benefit plans in real-time within a fixed monitor requires an interactive method that can toggle rapidly between documents. The GUIs described in the present invention provides this ability.

The platform of the present invention also provides search functionality for searching by a contact's name. This is advantageous in providing information about service providers, benefit brokers, and employers based on a key contact. In one embodiment, the present invention provides for generation of a custom contact list based on search results for contacts, service providers, benefit brokers, and employers, including contact names and contact information for each of the contacts such as phone number, email address, and LINKEDIN profile links.

In yet another embodiment, the present invention includes a web browser extension, such as an extension for GOOGLE CHROME, MOZILLA FIREFOX, or MICROSOFT EDGE. The extension is operable to provide contextual information about a contact, service provider, benefits broker, or company automatically upon the extension recognizing a name of a contact, service provider, benefits broker, or company on a web page. By way of example and not limitation, the plugin is operable to cause an overlay to be displayed with information on a web browser which has loaded a LINKEDIN page for a contact. The overlay includes text and/or links which provides information such as contact information (e.g., email, phone number, etc.) and a list of clients, associated service providers, employers, benefit brokers, etc. as applicable. Links are operable to be provided to webpages of the platform in one embodiment, including links to a list of clients, associated service providers, employers, benefit brokers, or a contact page of the contact.

In yet another embodiment, the present invention provides for importing a list of leads from a Customer Relationship Management (CRM) platform. The platform is operable to import and analyze these lists and add additional data to the existing list based on information from the platform which was missing or not available in the CRM platform. Additionally, the platform is operable to provide a suggestions engine which recommends new leads that look similar to existing leads. Leads include potential clients, service providers, employers, benefit brokers, or contacts in one embodiment of the present invention.

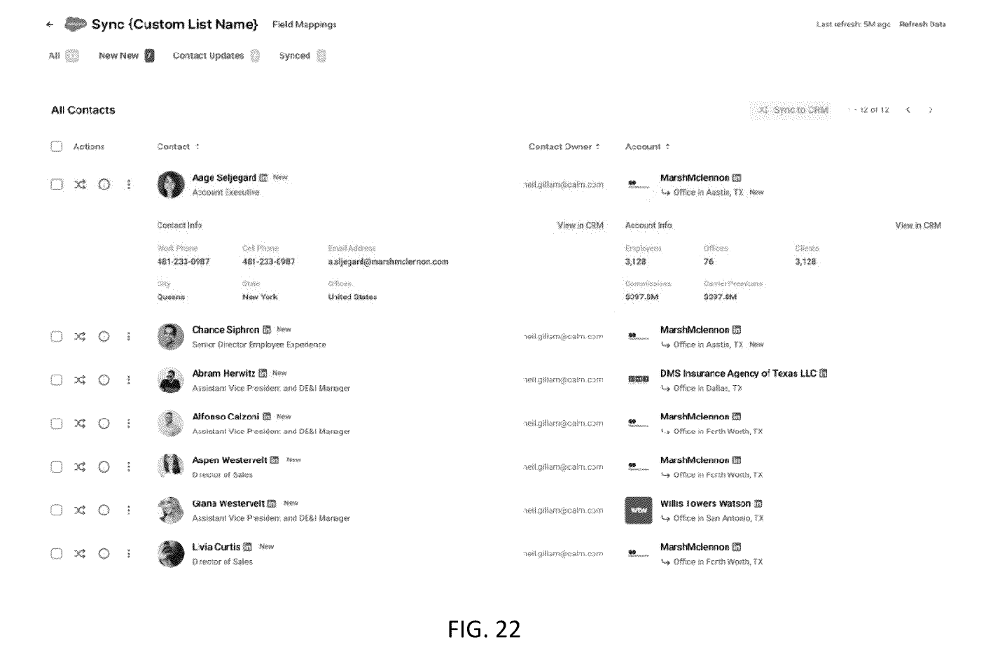

FIG. 22 illustrates a graphical user interface of a synchronization screen with a profile of a customer relationship management (CRM) profile according to one embodiment of the present invention. The CRM integration tool allows for the association of contacts not just to an account (like the individual “March McLennon” for example), but also to associate a contact with the office they belong to. This addresses a nuanced problem within the Benefits market, namely that platform users aren't just selling to individuals associated with single accounts, but to specific office locations within each account, which is represented by a complicated data hierarchy in the CRM. The present invention simplifies and automates the creation of this hierarchy by syncing over Parent Accounts, syncing over Office Locations (as Child Accounts that associate up to the relevant Parent Account), and then syncing over Contacts and associates them to the office they belong to.

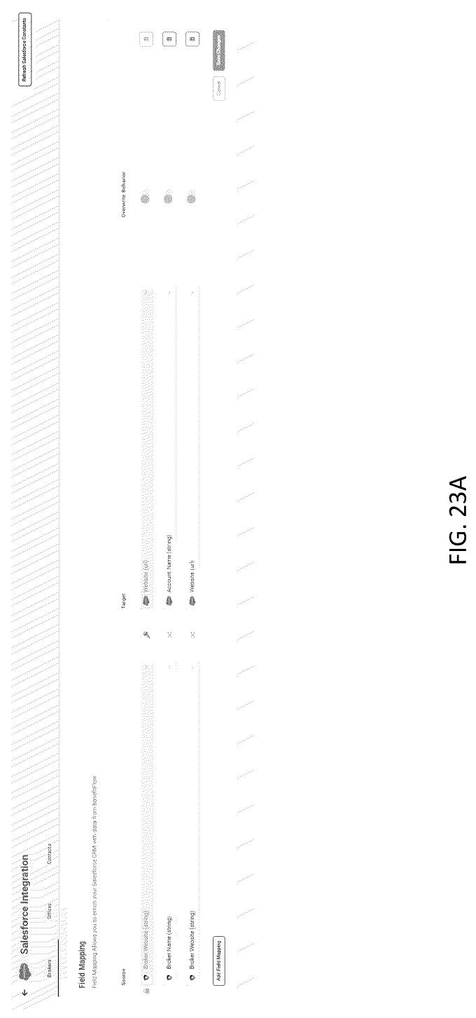

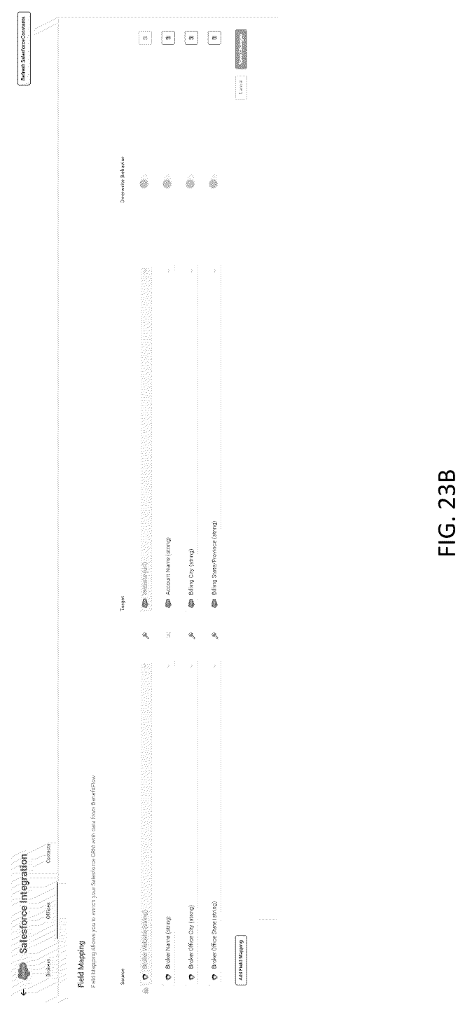

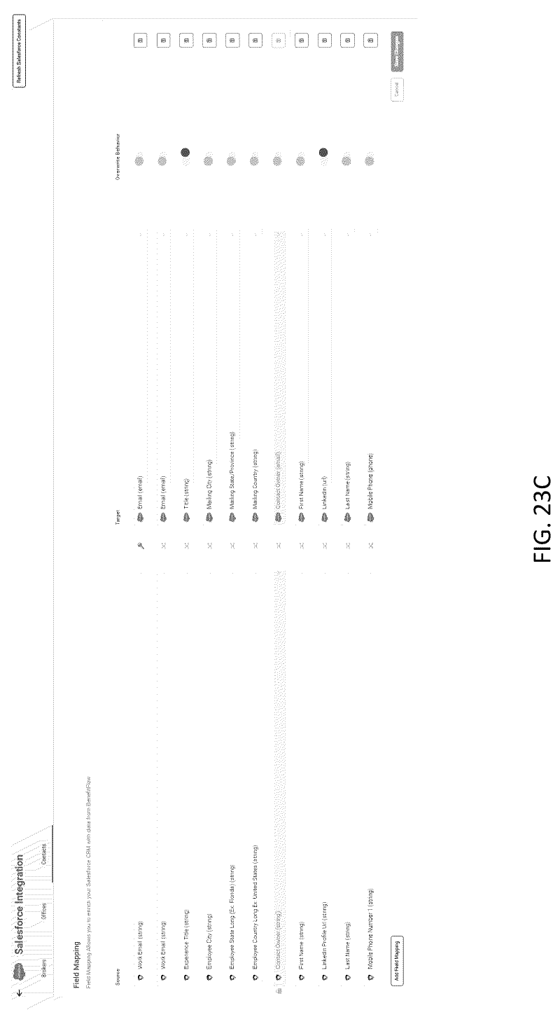

FIGS. 23A-23C illustrates mapping screens for broker data from customer relationship management (CRM) information according to one embodiment of the present invention. The screens in FIGS. 23A to 23C illustrate a mapping tool with fields corresponding to fields of a profile of a CRM account, across several types of data objects, including, but not limited to, brokers (corresponding to parent accounts), broker office locations (corresponding to one or more child accounts associated with the parent accounts), and broker contacts. The platform also provides for the syncing of employer accounts and associated employer contacts. Any field denoted with a key icon represents a field used for matching and duplicate detection. For example, if there is an account that shares a website with another account already existing in the database of the platform, the integration will not allow a new account to be created associated with that website, but instead overwrites and modifies the pre-existing account to include any relevant data as opposed to creating a duplicate. In one embodiment, the matching and duplicate detection is done by using websites, for accounts, and email addresses, for Contacts, while, in another embodiment, the matching and duplicate detection is done by office location. Because some users list 100 or more different office locations in a CRM account for a given brokerage, those 100 accounts that share the same website, meaning that website matching is poorly suited for child account de-duplication. Instead, the matching logic of the platform uses a combination of the website, the city, and the state in order to match and deduplicate when integrating with the CRM API.

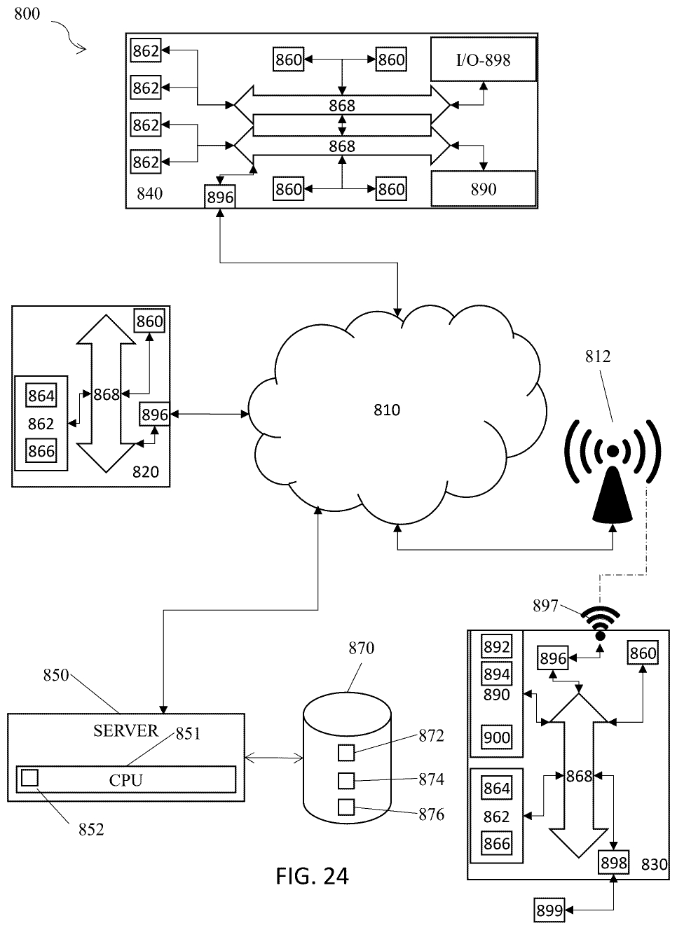

FIG. 24 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 24, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 24, is operable to include other components that are not explicitly shown in FIG. 24, or is operable to utilize an architecture completely different than that shown in FIG. 24. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

1. A system for aggregating and analyzing data from a multiplicity of websites for end-to-end prospecting comprising:
a server including a processor, a memory, and at least one database; and
a software application on an electronic device including a processor and a memory;
a web crawler; and
an artificial intelligence module, including natural language processing (NLP) algorithms;
wherein the server is in network communication with the electronic device;
wherein the server retrieves data from at least one government website;
wherein the artificial intelligence module analyzes benefits disclosure documents and normalize data extracted from the benefits disclosure documents;
wherein the web crawler collects and analyzes social data from one or more social media platforms;
wherein the web crawler programmatically receives the social data and automatically utilizes the social data to retrieve a social media profile uniform resource indicator (URL) associated with a company via a search engine;
wherein the web crawler utilizes the social media profile URL associated with the company to retrieve a company URL via scraping web data from the social media profile URL;
wherein the web crawler identifies job titles associated with the company;
wherein the server programmatically passes the company URL and the job titles to at least one third party via an application programming interface (API);
wherein the web crawler analyzes third-party data from at least one document from the at least one third party via the API, wherein the third-party data includes a name, a location, and an occupation;
wherein the social data includes contact information from at least one social media profile for a contact and the social media profile URL for the contact based on the data retrieved by the server from the at least one government website;
wherein the server transmits the contact information via the API;
wherein the server receives a curated set of contact information via the API;
wherein the server is periodically re-analyzes the social data from the one or more social media platform via the API to identify changes in the contact information, wherein changes in the contact information include changes in the job titles;
wherein the server automatically transmits at least one notification when the server identifies the changes in the contact information;
wherein the server automatically utilizes the API to retrieve new contact information upon identification of the changes in the contact information;
wherein the server determines a number of employees and/or a number of contacts associated with one or more broker office addresses based on the social data scraped by the web crawler;
wherein the contact information includes one or more broker office addresses corresponding to a benefits plan for at least one employer;
wherein distances between one or more broker office addresses and an office address of the at least one employer are automatically generated by the server based on geolocation data via a geolocation API corresponding to each address and a mapping module;
wherein the server associates the at least one employer with a most likely of the one or more broker office addresses based on the distance between the one or more broker office addresses and the office address of the at least one employer;
wherein the server automatically adds to or replaces the one or more broker office addresses corresponding to the benefits plan for the at least one employer with a new address selected from a list of office addresses for a broker providing the benefits plan;
wherein the new address is selected based on a correlation score with the at least one employer;
wherein the correlation score is based off a distance between the new address and the office address of the at least one employer and the number of employees and/or the number of contacts at the new address;
wherein the artificial intelligence module generates at least one set of cleaned and de-duplicated data in part by removing duplicate provider identify information and removing non-descriptive words via the NLP algorithms;
wherein the artificial intelligence module groups service provider identities, generates at least one name tag, generates a capitalization, and classifies at least one service provider type, wherein data treated by the artificial intelligence module forms the at least one set of cleaned and de-duplicated service provider identifying information based on the data retrieved from the at least one government website and the social data, wherein the data retrieved from the at least one government website and the social data is originally stored in different formats, thereby converting the data retrieved from the at least one government website and the social data into a standardized format;
wherein the artificial intelligence module generates a mapping table;
wherein the mapping table and the at least one set of cleaned and de-duplicated service provider identifying information is stored in at least one master database;
wherein the server analyzes the at least one master database to generate a second dataset;
wherein the second dataset fills at least one clean data database;
wherein the server constructs at least one client list including benefits broker data, employer data, and service provider data;
wherein the electronic device displays a graphical user interface (GUI) for the software application; and
wherein the GUI displays the at least one client list.

2. The system of claim 1, wherein the normalization of the data includes correcting errors in the data and removing article words including “a” and “the”.

3. The system of claim 1, wherein the contact information includes an electronic mail address of the contact.

4. The system of claim 1, wherein the server is further configured to determine contact information for the contact by determining a domain name of a website associated with the broker, the at least one employer, or a service provider based on a name of the broker, a name of the at least one employer, or a name of the service provider, retrieving data from a website associated with the broker, the at least one employer, or the service provide, creating a list of desired contacts at the broker, the employer, or the service provider, creating possible permutations of email addresses for the list of desired contacts based on names of the desired contacts and the domain name of the website associated with the broker, the at least one employer, or the service provider, and checking the possible permutations of email addresses for the desired contacts using an email checker webpage to determine valid email addresses for the desired contacts at the broker, the at least one employer, or the service provider.

5. The system of claim 1, wherein the contact is determined based on the data retrieved from the at least one government website.

6. The system of claim 1, wherein the contact is determined by retrieving a plurality of social media profiles on the at least one social media website based on the data retrieved from the at least one government website, analyzing the social media profiles, and selecting one or more contacts determined to be a likely gatekeeper for the broker, the employer, or the service provider.

7. The system of claim 1, wherein the server is further configured to retrieve data from at least one company website, wherein the server is configured to analyze the data from the at least one government website and the data from the at least one company website and identify at least one voluntary benefit and/or at least one employee perk not identified in the data from the at least one government website, and wherein the GUI is configured to display information about the at least one voluntary benefit and/or the at least one employee perk not identified in the data from the at least one government website.

8. The system of claim 1, wherein the NLP algorithms are configured for end-of-sentence detection, part-of-speech tagging, and chunking.

9. The system of claim 1, wherein the artificial intelligence module is configured to analyze the data from the at least one government website and the social data by breaking the text of the data from the at least one government website and the social data into sentences and/or words, assigning each sentence and/or letter a token, analyzing each token to generate a compound token, and assigning each compound token a label, wherein the label includes people, organization, plan, and/or location.

10. The system of claim 9, wherein the GUI is configured to receive a desired benefit plan, wherein the artificial intelligence module is configured to analyze the compound token, the data from the at least one government website, and/or the social data and determine one or more geographic locations with potential customers of the desired benefit plan, and wherein the GUI is configured to display a list of the potential customers of the desired benefit plan.

11. A method for aggregating and analyzing data from a multiplicity of websites for end-to-end prospecting comprising:
a server including a processor, a memory, an artificial intelligence module, and at least one database retrieving data from at least one government website;
the artificial intelligence module including natural language processing (NLP) algorithms grouping service provider identities, generating at least one name tag, generating a capitalization, and classifying at least one service provider type, forming at least one set of cleaned and de-duplicated service provider identifying information,
the server analyzing benefits disclosure documents and normalizing data extracted from the benefits disclosure documents using the NLP algorithms;
the server receiving social data from a web crawler, the social data including contact information from at least one social media profile for a contact and a social media profile uniform resource indicator (URL) for the contact based on the data retrieved by the server from the at least one government website;
the web crawler programmatically receiving the social data and automatically utilizing the social data to retrieve a social media profile uniform resource indicator (URL) associated with a company via a search engine;
the web crawler utilizing the social media profile URL associated with the company to retrieve a company URL via scraping web data from the social media profile URL, the company URL including job titles associated with the company;
the server programmatically passing the company URL and the job titles to at least one third party via an application programming interface (API);
the web crawler analyzing data from at least one document from the at least one third party via the API;
the server transmitting the contact information via an application programming interface (API);
the server receiving a curated set of contact information via the API;
the server periodically re-analyzing the social data from the one or more social media platform via the API to identify changes in the contact information;
the server automatically transmitting at least one notification when the server identifies the changes in the contact information;
the artificial intelligence module converting a format of the social data and a format of the data from the at least one government website to a standardized format;
the server constructing at least one client list including benefits broker data, employer data, and service provider data;
the server determining a number of employees and/or a number of contacts associated with at least one broker office address based on the social data from the web crawler;
the server automatically generating distances between the at least one broker office address and an office address of the at least one employer based on geolocation data via a geolocation API corresponding to each address and a mapping module;
the server associating the at least one employer with a most likely of the one or more broker office addresses based on the distance between the one or more broker office addresses and the office address of the at least one employer;
the server automatically replacing the at least one broker office address corresponding for a benefits plan for at least one employer with a new address selected from a list of office addresses for a broker providing the benefits plan;
a weighing formula determining the new address based off a distance between the new address and the office address of the at least one employer and based on the number of employees and/or the number of contacts at the new address;
the artificial intelligence module automatically determining at least one target geographical location for at least one benefits plan based on the contact information retrieved by the web crawler;
wherein the artificial intelligence module generates the at least one set of cleaned and de-duplicated data in part by removing duplicate provider identify information and removing non-descriptive words via the NLP algorithms;
the mapping module generating a mapping table;
storing the mapping table and the at least one set of cleaned and de-duplicated service provider identifying information in at least one master database;
the server analyzing the at least one master database to generate a second dataset;
the second dataset filling at least one clean data database;
an electronic device including a processor, a memory, and a software application, in network communication with the server, displaying a graphical user interface (GUI) for the software application, the GUI providing search functionality of the at least one database on the server for benefits broker data, employer data, and service provider data.

12. The method of claim 11, wherein the normalization of the data includes correcting errors in the data and removing article words including “a” and “the”.

13. The method of claim 11, wherein the contact information includes an electronic mail address of the contact.

14. The method of claim 11, further comprising the server determining contact information for the contact by determining a domain name of a website associated with the broker, the at least one employer, or the service provider based on a name of the broker, a name of the at least one employer, or a name of the service provider, retrieving data from a website associated with the broker, the at least one employer, or the service provide, creating a list of desired contacts at the broker, the at least one employer, or the service provider, creating possible permutations of email addresses for the list of desired contacts based on names of the desired contacts and the domain name of the website associated with the broker, the at least one employer, or the service provider, and checking the possible permutations of email addresses for the desired contacts using an email checker webpage to determine valid email addresses for the desired contacts at the broker, the at least one employer, or the service provider.

15. The method of claim 11, wherein the contact is determined based on the data retrieved from the at least one government website.

16. The method of claim 11, wherein the contact is determined by retrieving a plurality of social media profiles on the at least one social media website based on the data retrieved from the at least one government website, analyzing the plurality of social media profiles, and selecting one or more contacts determined to be a likely gatekeeper for the broker, the at least one employer, or the service provider.

17. The method of claim 11, further comprising the server retrieving data from at least one company website, analyzing the data from the at least one government website and the data from the at least one company website and identifying at least one voluntary benefit and/or at least one employee perk not identified in the data from the at least one government website, and the GUI displaying information about the at least one voluntary benefit and/or the at least one employee perk not identified in the data from the at least one government website.

18. The method of claim 11, wherein the NLP algorithms are configured for end-of-sentence detection, part-of-speech tagging, and chunking.

19. The method of claim 11, further comprising the artificial intelligence module analyzing the data from at least one government website and the social data by breaking the text of the data from at least one government website and the social data into sentences and/or words, assigning each sentence and/or letter a token, analyzing each token to generate a compound token, and assigning each compound token a label, wherein the label includes people, organization, plan, and/or location.

20. The method of claim 19, further comprising the GUI receiving a desired benefit plan, the artificial intelligence module analyzing the compound tokens, the data from at least one government website, and/or the social data and determine one or more geographic locations with potential customers of the desired benefit plan, and the GUI displaying a list of the potential customers of the desired benefit plan.
